(19) United States
(12) Patent Application Publication
(10) Pub. No.: US 2026/0104789 A1
(43) Pub. Date: Apr. 16, 2026

(54) WRIST WEARABLE ELECTRONIC DEVICE, METHOD, AND NON-TRANSITORY COMPUTER READABLE STORAGE MEDIUM FOR DISPLAYING CHANGED SCREEN BASED ON USER INPUT INFORMATION

(71) Applicant: SAMSUNG ELECTRONICS Co., LTD., Suwon-si (KR)

(72) Inventors: Nina LEE, Suwon-si (KR); Seungyong LEE, Suwon-si (KR); Yeunwook LIM, Suwon -si (KR); Junsu HWANG, Suwon-si (KR)

(73) Assignee: SAMSUNG ELECTRONICS CO., LTD., Suwon-si (KR)

(21) Appl. No.: 19/284,092

(22) Filed: Jul. 29, 2025

Related U.S. Application Data
(63) Continuation of application No. PCT/KR2025/010110, filed on Jul. 10, 2025.

(30) Foreign Application Priority Data
Oct. 15, 2024 (KR) 10-2024-0140755
Nov. 22, 2024 (KR) 10-2024-0169068

(51) Int. Cl. G06F 3/0485; G06F 1/16; G06F 3/01; G06F 3/0346

(52) U.S. Cl. CPC G06F 3/0485; G06F 1/163; G06F 3/017; G06F 3/0346

(57) ABSTRACT

A wrist-wearable electronic device includes a sensor, communication circuitry, a display, memory storing instructions, and at least one processor including processing circuitry. The instructions, when executed by the at least one processor individually or collectively, cause the wrist-wearable electronic device to, while a first screen is displayed, obtain information related to an angle between the wrist-wearable electronic device and a finger-wearable electronic device, determine whether the angle is included in a first angle range or a second angle range, based on user input information being received from the finger-wearable electronic device and the angle being in the first angle range display a second screen, and based on user input information being received from the finger-wearable electronic device and the angle being in the second angle range display a third screen.

### CROSS-REFERENCE TO RELATED APPLICATION(S)

This application is a continuation application, claiming priority under §365(c), of an International application No. PCT/KR2025/010110, filed on Jul. 10, 2025, which is based on and claims the benefit of a Korean patent application number 10-2024-0140755, filed on Oct. 15, 2024, in the Korean Intellectual Property Office, and of a Korean patent application number 10-2024-0169068, filed on Nov. 22, 2024, in the Korean Intellectual Property Office, the disclosure of each of which is incorporated by reference herein in its entirety.

### FIELD

The disclosure relates to a wrist-wearable electronic device, a method, and a non-transitory computer-readable storage medium for displaying a changed screen based on user input information.

### DESCRIPTION OF RELATED ART

A wrist-wearable electronic device may include a strap. The wrist-wearable electronic device may operate while being worn on a wrist of a user using the strap. The wrist-wearable electronic device may provide a service in a state of being worn on the wrist of the user.

The above information is presented as background information only to assist with an understanding of the present disclosure. No determination has been made, and no assertion is made, as to whether any of the above might be applicable prior art with regard to the present disclosure.

### SUMMARY

In accordance with an aspect of the disclosure, a wrist-wearable electronic device is provided. The wrist-wearable electronic device may comprise a sensor. The wrist-wearable electronic device may comprise communication circuitry. The wrist-wearable electronic device may comprise a display. The wrist-wearable electronic device may comprise memory, comprising one or more storage media, storing instructions. The wrist-wearable electronic device may comprise at least one processor comprising processing circuitry. The instructions, when executed by the at least one processor individually or collectively, may cause the wrist-wearable electronic device to, while a first screen is displayed via the display, based on sensor data obtained via the sensor, obtain information related to an angle between the wrist-wearable electronic device and a finger-wearable electronic device connected to the wrist-wearable electronic device. The instructions, when executed by the at least one processor individually or collectively, may cause the wrist-wearable electronic device to, based on the information related to the angle, determine, in a first determination, whether the angle is included in a first angle range or a second angle range distinguished from the first angle range. The instructions, when executed by the at least one processor individually or collectively, may cause the wrist-wearable electronic device to, receive, via the communication circuitry, a user input information for the finger-wearable electronic device from the finger-wearable electronic device. The instructions, when executed by the at least one processor individually or collectively, may cause the wrist-wearable electronic device to, based on the user input information being received from the finger-wearable electronic device and the first determination indicating that the angle is included in the first angle range, display, via the display, a second screen changed from the first screen. The instructions, when executed by the at least one processor individually or collectively, may cause the wrist-wearable electronic device to, based on the user input information being received from the finger-wearable electronic device and the first determination indicating that the angle is included in the second angle range, display, via the display, a third screen, changed from the first screen, distinguished from the second screen.

In accordance with an aspect of the disclosure, a method is provided. The method may be performed by a wrist-wearable electronic device with a display, communication circuitry, and a sensor. The method may comprise, while a first screen is displayed via the display, based on sensor data obtained via the sensor, obtain information related to an angle between the wrist-wearable electronic device and a finger-wearable electronic device connected to the wrist-wearable electronic device. The method may comprise, based on the information related to the angle, determine, in a first determination, whether the angle is included in a first angle range or a second angle range distinguished from the first angle range. The method may comprise, receive, via the communication circuitry, a user input information for the finger-wearable electronic device from the finger-wearable electronic device. The method may comprise, based on the user input information being received from the finger-wearable electronic device and the first determination indicating that the angle is included in the first angle range, display, via the display, a second screen changed from the first screen. The method may comprise, based on the user input information being received from the finger-wearable electronic device and the first determination indicating that the angle is included in the second angle range, display, via the display, a third screen, changed from the first screen, distinguished from the second screen.

In accordance with an aspect of the disclosure, a non-transitory computer readable storage medium is provided. The non-transitory computer readable storage medium may store one or more programs. The one or more programs may comprise instructions to, when executed by a wrist-wearable electronic device with a display, communication circuitry, and a sensor, cause the wrist-wearable electronic device to, while a first screen is displayed via the display, based on sensor data obtained via the sensor, obtain information related to an angle between the wrist-wearable electronic device and a finger-wearable electronic device connected to the wrist-wearable electronic device. The one or more programs may comprise instructions to, when executed by the wrist-wearable electronic device, cause the wrist-wearable electronic device to, based on the information related to the angle, determine, in a first determination, whether the angle is included in a first angle range or a second angle range distinguished from the first angle range. The one or more programs may comprise instructions to, when executed by the wrist-wearable electronic device, cause the wrist-wearable electronic device to, receive, via the communication circuitry, a user input information for the finger-wearable electronic device from the finger-wearable electronic device. The one or more programs may comprise instructions to, when executed by the wrist-wearable electronic device, cause the wrist-wearable electronic device to, based on the user input information being received from the finger-wearable electronic device and the first determination indicating that the angle is included in the first angle range, display, via the display, a second screen changed from the first screen. The one or more programs may comprise instructions to, when executed by the wrist-wearable electronic device, cause the wrist-wearable electronic device to, based on the user input information being received from the finger-wearable electronic device and the first determination indicating that the angle is included in the second angle range, display, via the display, a third screen, changed from the first screen, distinguished from the second screen.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a block diagram of an electronic device in a network environment according to an embodiment;

FIGS. 2A and 2B illustrate perspective views of an electronic device according to an embodiment;

FIG. 3 illustrates an exploded perspective view of an electronic device according to an embodiment;

FIG. 4 is a simplified block diagram of a wrist-wearable electronic device and a finger-wearable electronic device according to an embodiment;

FIG. 5 illustrates an example of screens displayed by a wrist-wearable electronic device through a display according to an embodiment;

FIG. 6 illustrates an example of an angle between a wrist-wearable electronic device and a finger-wearable electronic device according to an embodiment;

FIG. 7 illustrates an example of operations of a wrist-wearable electronic device for displaying a changed screen based on user input information according to an embodiment;

FIG. 8 illustrates an example of a wrist-wearable electronic device that displays visual objects in accordance with whether an angle between the wrist-wearable electronic device and a finger-wearable electronic device is included within a first angle range or a second angle range according to an embodiment;

FIGS. 9A and 9B illustrate an example of a wrist-wearable electronic device that displays a changed screen, based on user input information received from a finger-wearable electronic device according to an embodiment;

FIG. 10 illustrates an example of a wrist-wearable electronic device that corrects an angle between the wrist-wearable electronic device and a finger-wearable electronic device according to an embodiment;

FIG. 11 illustrates an example of a wrist-wearable electronic device that displays different types of scroll animations in accordance with user input information according to an embodiment;

FIG. 12 illustrates an example of operations of a wrist-wearable electronic device providing a gesture mode according to an embodiment;

FIG. 13 illustrates an example of a wrist-wearable electronic device that executes a function corresponding to a gesture input according to an embodiment;

FIG. 14A illustrates a wearable device according to an embodiment; and

FIG. 14B is a cross-sectional view of a wearable device according to an embodiment.

### DETAILED DESCRIPTION

Hereinafter, embodiments are described in detail with reference to the accompanying drawings.

Terms used in the present disclosure are used only to describe embodiments, and may not be intended to limit a range of another embodiment. A singular expression may include a plural expression unless the context clearly means otherwise. Terms used herein, including a technical or a scientific term, may have the same meaning as those generally understood by a person with ordinary skill in the art described in the present disclosure. Among the terms used in the present disclosure, terms defined in a general dictionary may be interpreted as identical or similar meaning to the contextual meaning of the relevant technology and are not interpreted as ideal or excessively formal meaning unless explicitly defined in the present disclosure. In some cases, even terms defined in the present disclosure may not be interpreted to exclude embodiments.

In various embodiments described below, a hardware approach will be described as an example. However, because the various embodiments include technology that uses hardware that operates according to software instructions, the various embodiments do not exclude a software-based approach.

Terms referring to data (e.g., data, information, scroll information, gyro information, user input information, signal, sensor data), terms referring to a value (e.g., reference time, reference number, reference user input information, number of failures, number of changes), terms for an operation state (e.g., operation, process), terms referring to an object (e.g., visual object, indicator), terms referring to network entities, terms referring to a component of a device, and the like, used in the following description are exemplified for convenience of explanation. Therefore, the present disclosure is not limited to terms to be described below, and another term having an equivalent technical meaning may be used.

In addition, in the present disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}. As used herein, the terms ‘1st’ or ‘first’ and ‘2nd’ or ‘second’ may use corresponding components regardless of importance or order and are used to distinguish a component from another component without limiting the components. Expressions such as ‘at least one of’ when preceding a list of elements, modify the entire list of elements and do not modify the individual elements of the list. For example, the expression, ‘at least one of a, b, and c, ’ should be understood as including only a, only b, only c, both a and b, both a and c, both b and c, or all of a, b, and c.

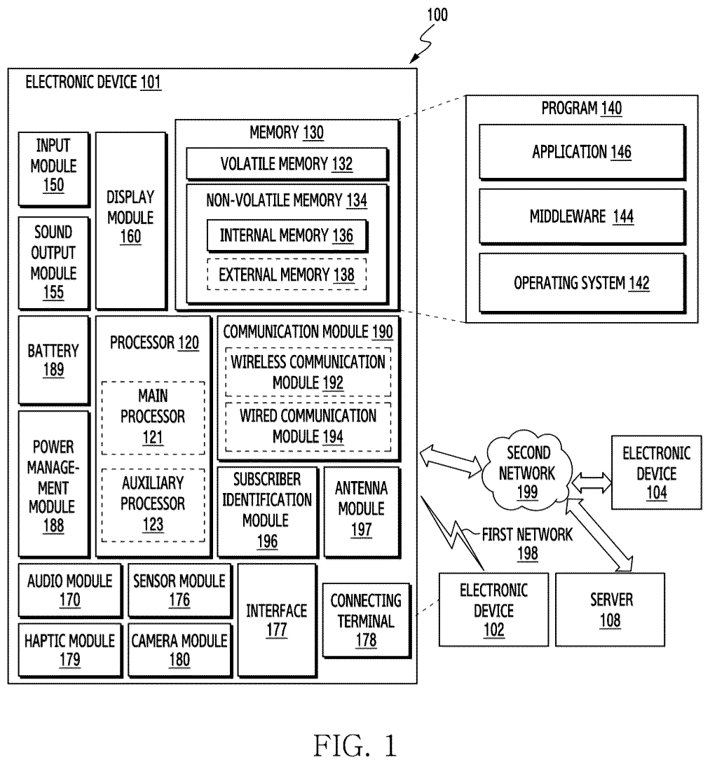

FIG. 1 is a block diagram illustrating an electronic device 101 in a network environment 100 according to various embodiments.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but embodiments are not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

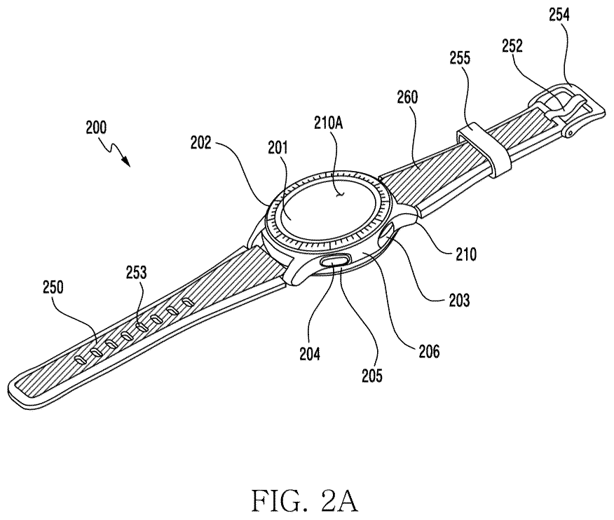

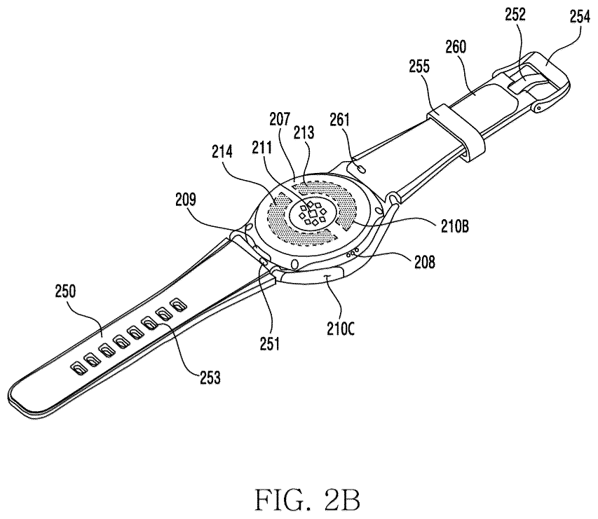

FIGS. 2A and 2B illustrate perspective views of an electronic device according to an embodiment.

Referring to FIGS. 2A and 2B, an electronic device 200 (e.g., the electronic device 101 of FIG. 1) according to an embodiment may include a housing 210 that includes a first surface (or front surface) 210A, a second surface (or rear surface) 210B, and a side surface 210C surrounding a space between the first surface 210A and the second surface 210B, and fastening members 250 and 260 connected to at least a portion of the housing 210 and configured to detachably fasten the electronic device 200 to a body part (e.g., wrist or ankle) of a user. In another embodiment, the housing may also refer to a structure forming a portion of the first surface 210A, the second surface 210B, and the side surface 210C of FIGS. 2A and 2B. According to an embodiment, at least a portion of the first surface 210A may be formed of a front plate 201 that is at least partially substantially transparent (e.g., a glass plate or a polymer plate, including various coating layers). The second surface 210B may be formed by a rear plate 207 that is substantially opaque. For example, the rear plate 207 may be formed of coated or colored glass, ceramic, polymer, metal (e.g., aluminum, stainless steel (STS), or magnesium), or a combination of at least two of the above materials. The side surface 210C may be formed by a side bezel structure (or “side member”) 206, coupled to the front plate 201 and the rear plate 207 and including metal and/or polymer. In some embodiments, the rear plate 207 and the side bezel structure 206 may be integrally formed and include the same material (e.g., a metallic material such as aluminum). The fastening members 250 and 260 may be formed in various materials and shapes. The fastening members 250 and 260 may be integrally formed to be movable or formed a plurality of unit links that are movable relative to each other, by woven fabric, leather, rubber, urethane, metal, ceramic, or a combination of at least two of the above materials.

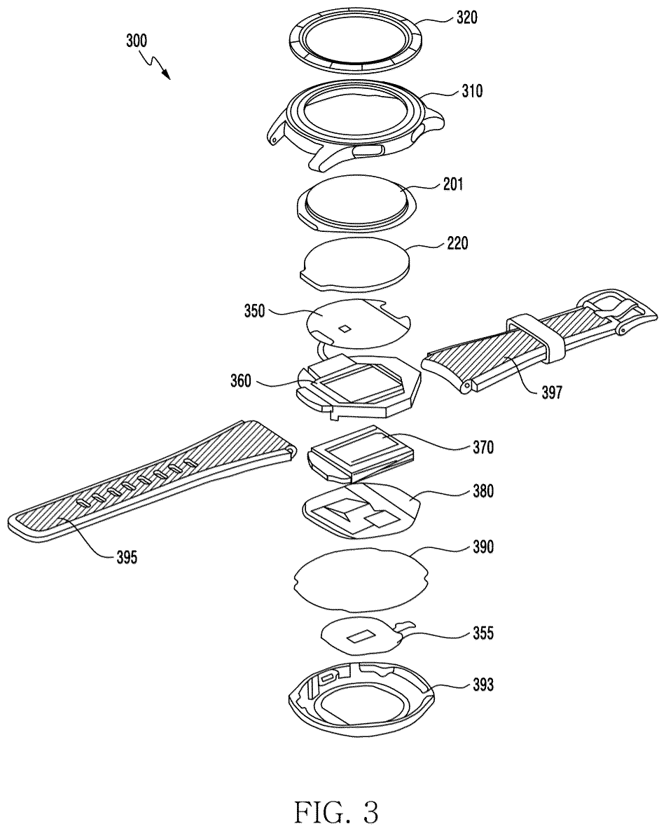

According to an embodiment, the electronic device 200 may include at least one of a display 220 (referring to FIG. 3), audio modules 205 and 208, a sensor module 211, key input devices 202, 203, 204, and a connector hole 209. In some embodiments, the electronic device 200 may omit at least one (e.g., the key input devices 202, 203, and 204, the connector hole 209, or the sensor module 211) of components or may additionally include another component.

For example, the display 220 may be visually exposed through a significant portion of the front plate 201. A shape of the display 220 may be a shape corresponding to a shape of the front plate 201, and may be various shapes such as a circle, an oval, or a polygon. The display 220 may be coupled to or disposed adjacent to touch sensing circuitry, a pressure sensor capable of measuring intensity (pressure) of a touch, and/or a fingerprint sensor.

The audio modules 205 and 208 may include a microphone hole 205 and a speaker hole 208. In the microphone hole 205, a microphone for obtaining an external sound may be disposed therein, and in some embodiments, a plurality of microphones may be disposed to detect a direction of the sound. The speaker hole 208 may be used as an external speaker and the microphone hole 205 may be used as a call receiver. In some embodiments, the speaker hole 208 and the microphone hole 205 may be implemented as one hole, or a speaker may be included without the speaker hole 208 (e.g., a piezo speaker).

The sensor module 211 may generate an electrical signal or a data value corresponding to an internal operating state of the electronic device 200 or an external environmental state. For example, the sensor module 211 may include a biometric sensor module 211 (e.g., an HRM sensor) disposed on the second surface 210B of the housing 210. The electronic device 200 may further include at least one additional sensor module, for example, a gesture sensor, a gyro sensor, a barometric sensor, a magnetic sensor, an acceleration sensor, a grip sensor, a color sensor, an infrared (IR) sensor, a biometric sensor, a temperature sensor, a humidity sensor, or an illuminance sensor.

The sensor module 211 may include electrode regions 213 and 214 forming a portion of a surface of the electronic device 200 and a bio-signal detection circuit electrically connected to the electrode regions 213 and 214. For example, the electrode regions 213 and 214 may include a first electrode region 213 and a second electrode region 214 disposed on the second surface 210B of the housing 210. The sensor module 211 may be configured such that the electrode regions 213 and 214 obtain an electrical signal from a body part of a user, and the bio-signal detection circuit detects biometric information of the user based on the electrical signal.

The key input devices 202, 203, and 204 may include a wheel key 202 disposed on the first surface 210A of the housing 210 and rotatable in at least one direction, and/or side key buttons 203 and 204 disposed on the side surface 210C of the housing 210. The wheel key may have a shape corresponding to the shape of the front plate 201. In another embodiment, the electronic device 200 may not include some or all of the key input devices 202, 203, and 204 mentioned above, and the key input devices 202, 203, and 204 that are not included may be implemented on the display 220 in another form, such as a soft key. The connector hole 209 may accommodate a connector (e.g., a USB connector) for transmitting and receiving power and/or data with an external electronic device and may include another connector hole for transmitting and receiving an audio signal with an external electronic device. For example, the electronic device 200 may further include a connector cover covering at least a portion of the connector hole 209 and blocking an inflow of external foreign substances into the connector hole.

The fastening members 250 and 260 may be detachably fastened to at least a portion of the housing 210 by using locking members 251 and 261. The fastening members 250 and 260 may include one or more of a fixing member 252, a fixing member fastening hole 253, a band guide member 254, and a band fixing ring 255.

The fixing member 252 may be configured to fix the housing 210 and the fastening members 250 and 260 to a body part (e.g., wrist or ankle) of the user. The fixing member fastening hole 253 may fix the housing 210 and the fastening members 250 and 260 to a body part of the user by corresponding to the fixing member 252. The band guide member 254 may be configured to limit a movement range of the fixing member 252 when the fixing member 252 is fastened with the fixing member fastening hole 253, so that the fastening members 250 and 260 may be fastened in close contact with a body part of the user. The band fixing ring 255 may limit a movement range of the fastening members 250 and 260 in a state in which the fixing member 252 and the fixing member fastening hole 253 are fastened.

FIG. 3 illustrates an exploded perspective view of an electronic device according to an embodiment.

Referring to FIG. 3, an electronic device 300 (e.g., the electronic device 101 of FIG. 1 or the electronic device 200 of FIG. 2A or 2B) may include a side bezel structure 310, a wheel key 320 (e.g., the wheel key 202 of FIG. 2A), a front plate 201, a display 220, a first antenna 350, a second antenna 355, a support member 360 (e.g., bracket), a battery 370, a printed circuit board 380, a sealing member 390, a rear plate 393 (e.g., the rear plate 207 of FIG. 2B), and fastening members 395 and 397 (e.g., the fastening members 250 and 260 of FIGS. 2A and 2B). At least one of components of the electronic device 300 may be the same as or similar to at least one of the components of the electronic device 200 of FIGS. 1 or 2A to 2B, and a redundant description is omitted below. The support member 360 disposed inside the electronic device 300 may be connected to the side bezel structure 310, or may be integrally formed with the side bezel structure 310. The support member 360 may be formed of, for example, a metal material and/or a non-metal material (e.g., polymer). In the support member 360, the display 220 may be coupled to a surface and the printed circuit board 380 may be coupled to another surface. A processor, memory, and/or an interface may be mounted on the printed circuit board 380. The processor may include, for example, one or more of a central processing unit, a graphic processing unit (GPU), an application processor, a sensor processor, or a communication processor.

The memory may include, for example, a volatile memory or a nonvolatile memory. The interface may include, for example, a high-definition multimedia interface (HDMI), a universal serial bus (USB), an SD card interface, and/or an audio interface. For example, the interface may electrically or physically connect the electronic device 300 to an external electronic device, and may include a USB connector, an SD card/MMC connector, or an audio connector.

For example, the battery 370, which is a device for supplying power to at least one component of the electronic device 300, may include a non-rechargeable primary battery, a rechargeable secondary battery, or a fuel cell. For example, at least a portion of the battery 370 may be disposed on substantially the same plane as the printed circuit board 380. The battery 370 may be integrally disposed inside the electronic device 200 or may be detachably disposed from the electronic device 200.

The first antenna 350 may be disposed between the display 220 and the support member 360. For example, the first antenna 350 may include a near field communication (NFC) antenna, a wireless charging antenna, and/or a magnetic secure transmission (MST) antenna. For example, the first antenna 350 may perform short-range communication with an external device, wirelessly transmit/receive power required for charging, and transmit a short-range communication signal or a self-based signal including payment data. In another embodiment, an antenna structure may be formed by a portion or a combination of the side bezel structure 310 and/or the support member 360.

The second antenna 355 may be disposed between the printed circuit board 380 and the rear plate 393. For example, the second antenna 355 may include a near field communication (NFC) antenna, a wireless charging antenna, and/or a magnetic secure transmission (MST) antenna. For example, the second antenna 355 may perform short-range communication with an external device, wirelessly transmit/receive power required for charging, and transmit a short-range communication signal or a self-based signal including payment data. In another embodiment, an antenna structure may be formed by a portion or a combination of the side bezel structure 310 and/or the rear plate 393.

The sealing member 390 may be positioned between the side bezel structure 310 and the rear plate 393. The sealing member 390 may be configured to block moisture and foreign substances flowing into a space surrounded by the side bezel structure 310 and the rear plate 393 from the outside.

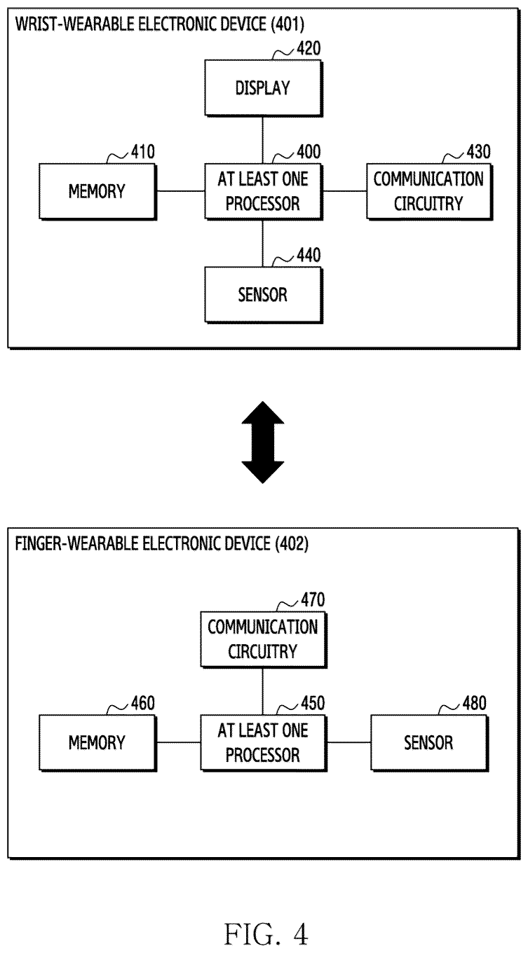

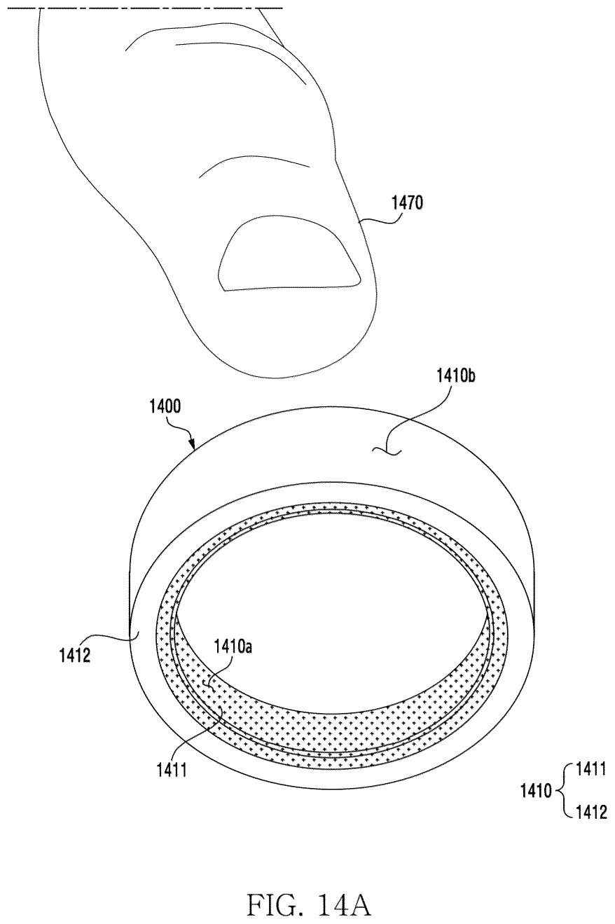

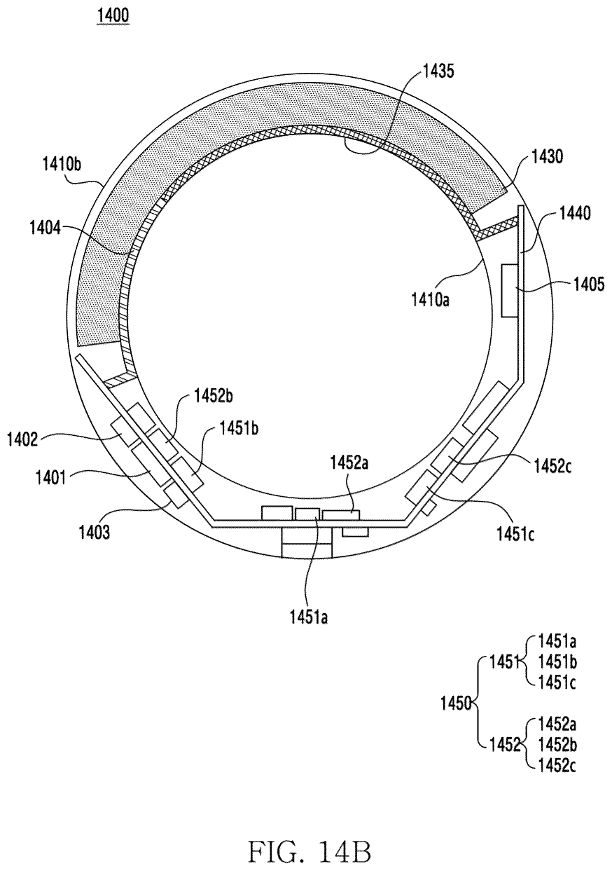

FIG. 4 is a simplified block diagram of a wrist-wearable electronic device 401 (e.g., the electronic device 101 of FIG. 1, the electronic device 200 of FIGS. 2A and 2B, the electronic device 300 of FIG. 3) and a finger-wearable electronic device 402 (e.g., the electronic device 101 of FIG. 1, the electronic device 1400 of FIGS. 14A and 14B) according to an embodiment. The wrist-wearable electronic device 401 may include a wearable device. The wrist-wearable electronic device 401 may include a watch-type electronic device. For example, the wrist-wearable electronic device 401 may include a smart watch. The finger-wearable electronic device 401 may include a wearable device. The finger-wearable electronic device 401 may include a ring-type electronic device. For example, the finger-wearable electronic device 401 may include a smart ring.

Referring to FIG. 4, the wrist-wearable electronic device 401 may include at least one processor 400, memory 410, a display 420, communication circuitry 430, and/or a sensor 440.

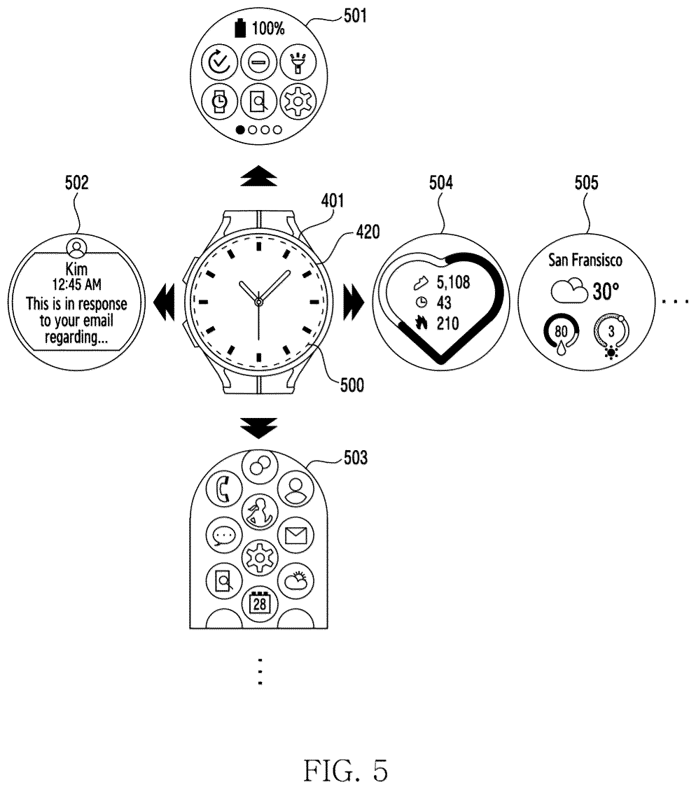

The at least one processor 400 may include a hardware component for processing data based on executing instructions. For example, a hardware component for processing data may include a central processing unit (CPU) (e.g., including processing circuitry). For example, a hardware component for processing data may include a graphic processing unit (GPU) (e.g., including processing circuitry). For example, a hardware component for processing data may include a display processing unit (DPU) (e.g., including processing circuitry). For example, a hardware component for processing data may include a neural processing unit (NPU) (e.g., including processing circuitry). The at least one processor 400 may include one or more cores. For example, the at least one processor 400 may have a structure of a multi-core processor such as a dual core, a quad core, or a hexa core. The wrist-wearable electronic device 401 illustrated in the description of FIG. 4 may execute at least a portion of operations illustrated in the description of FIGS. 5 to 13. For example, the operations illustrated in the description of FIGS. 5 to 13 may be caused by (or within) the wrist-wearable electronic device 401 in accordance with the control of the at least one processor 400.

The memory 410 may include a hardware component for storing data and/or instructions inputted to and/or outputted from the at least one processor 400. For example, the memory 410 may include a volatile memory such as a random-access memory (RAM) and/or a non-volatile memory such as a read-only memory (ROM). For example, the volatile memory may include at least one of a dynamic RAM (DRAM), a static RAM (SRAM), a cache RAM, or a pseudo SRAM (PSRAM). For example, the non-volatile memory may include at least one of a programmable ROM (PROM), an erasable PROM (EPROM), an electrically erasable PROM (EEPROM), a flash memory, a hard disk, a compact disc, or an embedded multimedia card (EMMC).

The display 420 may include a hardware component of the wrist-wearable electronic device 401 used to display a screen. For example, the display 420 may include light-emitting elements and circuits (e.g., transistors) that control the light-emitting elements to emit light. For example, each of the light emitting elements may include an organic light emitting diode (OLED) or a micro LED. However, embodiments are not limited thereto. For example, the display 420 may include a liquid crystal display (LCD).

According to an embodiment, the display 420 may include a sensor (e.g., a touch sensor panel (TSP)) for detecting an external object (e.g., a user's finger) on the display 420. For example, based on the TSP, the wrist-wearable electronic device 401 may detect an external object contacting with the display 420 or floating on the display 420. In response to detecting the external object, the wrist-wearable electronic device 401 may execute a function related to a specific visual object displayed at a position on the display 420 contacted with the external object among visual objects displayed on the display 420.

The communication circuitry 430 may include a hardware component for supporting transmission and/or reception of a signal between the wrist-wearable electronic device 401 and an external electronic device (e.g., the finger-wearable electronic device 402). For example, the communication circuitry 430 may include at least one of a modem, an antenna, or an optic/electronic (O/E) converter. The communication circuitry 430 may support transmission and/or reception of an electrical signal based on various types of protocols such as Ethernet, local area network (LAN), wide area network (WAN), wireless fidelity (Wi-Fi), Bluetooth, Bluetooth low energy (BLE), Zigbee, long term evolution (LTE), 5G new radio (NR), and ultra-wideband (UWB).

The sensor 440 may include at least one of an inertial measurement unit (IMU) sensor and a biometric sensor. However, embodiments are not limited thereto. The wrist-wearable electronic device 401 may obtain sensor data via the sensor 440. The wrist-wearable electronic device 401 may obtain information related to an angle between the wrist-wearable electronic device 401 and the finger-wearable electronic device 402 by using the sensor data. The wrist-wearable electronic device 401 may obtain a gesture input of a user by using the sensor data.

According to an embodiment, the IMU sensor may include at least one of an acceleration sensor, a geomagnetic sensor, and a gyro sensor. The acceleration sensor and the geomagnetic sensor may be included in the wrist-wearable electronic device 401 to measure a physical movement of the wrist-wearable electronic device 401. The gyro sensor may be included in the wrist-wearable electronic device 401 to measure a rotation of the wrist-wearable electronic device 401. The wrist-wearable electronic device 401 may obtain information related to an angle between the wrist-wearable electronic device 401 and the finger-wearable electronic device 402 by using IMU sensor data obtained via the IMU sensor. The wrist-wearable electronic device 401 may recognize a movement of a hand connected to a wrist wearing the wrist-wearable electronic device 401 by using the IMU sensor data. The wrist-wearable electronic device 401 may obtain a gesture input of the hand.

According to an embodiment, the biometric sensor may be used to obtain biometric data of a user of the wrist-wearable electronic device 401. For example, the biometric data may include data related to blood pressure, body temperature, heart rate, stress index, and/or fingerprint. The wrist-wearable electronic device 401 may recognize a movement of a hand connected to a wrist wearing the wrist-wearable electronic device 401 by using the obtained biometric data. The wrist-wearable electronic device 401 may obtain a gesture input of the hand by using the obtained biometric data.

The finger-wearable electronic device 402 may include at least one processor 450, memory 460, communication circuitry 470, and/or a sensor 480.

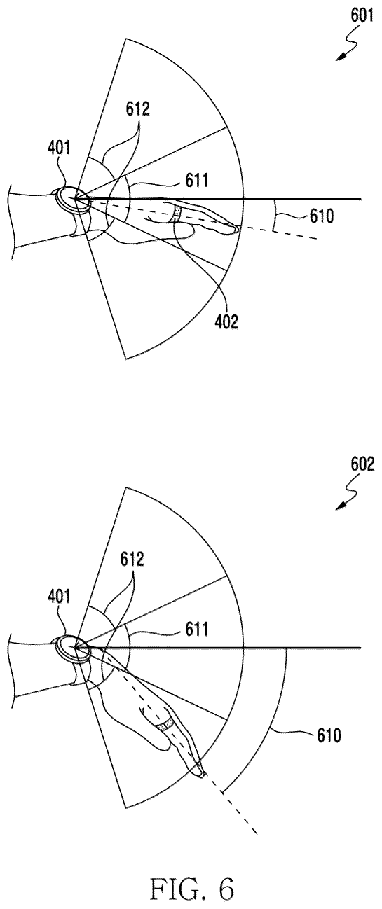

The at least one processor 450 may include a hardware component for processing data based on executing instructions. For example, a hardware component for processing data may include a central processing unit (CPU) (e.g., including processing circuitry). For example, a hardware component for processing data may include a graphic processing unit (GPU) (e.g., including processing circuitry). For example, a hardware component for processing data may include a display processing unit (DPU) (e.g., including processing circuitry). For example, a hardware component for processing data may include a neural processing unit (NPU) (e.g., including processing circuitry). The at least one processor 450 may include one or more cores. For example, the at least one processor 450 may have a structure of a multi-core processor such as a dual core, a quad core, or a hexa core. The finger-wearable electronic device 402 illustrated in the description of FIG. 4 may execute at least a portion of the operations illustrated in the description of FIGS. 6 to 13. For example, the operations illustrated in the description of FIGS. 6 to 13 may be caused by (or within) the finger-wearable electronic device 402 in accordance with the control of the at least one processor 450.

The memory 460 may include a hardware component for storing data and/or instructions inputted to and/or outputted from the at least one processor 450. For example, the memory 460 may include a volatile memory, such as a random-access memory (RAM), and/or a non-volatile memory, such as a read-only memory (ROM). For example, the volatile memory may include at least one of a dynamic RAM (DRAM), a static RAM (SRAM), a cache RAM, or a pseudo SRAM (PSRAM). For example, the nonvolatile memory may include at least one of a programmable ROM (PROM), an erasable PROM (EPROM), an electrically erasable PROM (EEPROM), a flash memory, a hard disk, a compact disc, or an embedded multimedia card (EMMC).

The communication circuitry 470 may include a hardware component for supporting transmission and/or reception of a signal between the finger-wearable electronic device 402 and an external electronic device (e.g., the wrist-wearable electronic device 401). For example, the communication circuitry 470 may include at least one of a modem, an antenna, or an optic/electronic (O/E) converter. The communication circuitry 470 may support transmission and/or reception of an electrical signal based on various types of protocols, such as Ethernet, local area network (LAN), wide area network (WAN), wireless fidelity (Wi-Fi), Bluetooth, Bluetooth low energy (BLE), Zigbee, long term evolution (LTE), 5G new radio (NR), and ultra-wideband (UWB).

The sensor 480 may include at least one of a touch sensor, an inertial measurement unit (IMU) sensor, and a proximity sensor. However, embodiments are not limited thereto.

According to an embodiment, the touch sensor may identify an external object (e.g., the user's body) in contact with the finger-wearable electronic device 402. For example, the touch sensor may be disposed on a surface facing the outside of a housing of the finger-wearable electronic device 402 to identify an external object (e.g., the user's body) in contact with the surface. For example, the finger-wearable electronic device 402 may receive a touch input based on identifying the external object in contact with the touch sensor. For example, the touch input may include a scroll input.

According to an embodiment, the IMU sensor may include at least one of an acceleration sensor, a geomagnetic sensor, and a gyro sensor. The acceleration sensor and the geomagnetic sensor may be included in the finger-wearable electronic device 402 to measure a physical movement of the finger-wearable electronic device 402. The gyro sensor may be included in the finger-wearable electronic device 402 to measure a rotation of the finger-wearable electronic device 402. For example, the gyro sensor may output sensor data indicating a parameter (e.g., angular velocity) indicating a rotation of the finger-wearable electronic device 402, based on a plurality of designated axes (e.g., x-axis, y-axis, z-axis) perpendicular to each other. The sensor data indicating a parameter (e.g., angular velocity) indicating a rotation of the finger-wearable electronic device 402 may be referred to as gyro information.

According to an embodiment, the proximity sensor may identify an external object (e.g., the user's body) spaced apart from the finger-wearable electronic device 402 by a specified distance or less. For example, the proximity sensor may be disposed on a surface facing the outside of a housing of the finger-wearable electronic device 402 to identify an external object (e.g., the user's body) adjacent to the surface. In a state of identifying an external object spaced apart from the finger-wearable electronic device 402 by a specified distance or less, the proximity sensor may output sensor data indicating a distance between the finger-wearable electronic device 402 and the external object. The proximity sensor may be used to identify an external object interacting with the finger-wearable electronic device 402.

In the present disclosure, a technique for changing a screen displayed via the display 420, based on user input information of the wrist-wearable electronic device 401 may be described. The user input information may be received from the finger-wearable electronic device 402 connected to the wrist-wearable electronic device 401. The screen displayed via the display 420 will be described and exemplified in more detail with reference to FIG. 5.

FIG. 5 illustrates an example of screens displayed by a wrist-wearable electronic device 401 via a display 420 according to an embodiment.

Referring to FIG. 5, the wrist-wearable electronic device 401 may display a plurality of screens via the display 420. For example, the wrist-wearable electronic device 401 may display a screen 500 via the display 420. While displaying the screen 500, the wrist-wearable electronic device 401 may receive a user input. The user input may be described as an input for changing the screen 500 displayed by the display 420. For example, the user input may include an input for moving a contact point in a direction. For example, the user input may include a swipe input (or scroll input).

According to an embodiment, the wrist-wearable electronic device 401 may display a screen 501 via the display 420, in response to receiving a user input while displaying the screen 500. The user input may cause the screen 500 to be scrolled in a first direction. The screen 501 may include at least one visual object for providing functions for changing a setting of the wrist-wearable electronic device 401. The screen 501 may be referred to as a quick panel page. In response to receiving an input for at least one visual object, the wrist-wearable electronic device 401 may change a setting related to the at least one visual object or execute a function related to the at least one visual object.

According to an embodiment, while displaying the screen 501, the wrist-wearable electronic device 401 may receive an input causing the screen 501 to be scrolled in a second direction perpendicular to the first direction. In response to receiving the input causing the screen 501 to be scrolled in the second direction perpendicular to the first direction, the wrist-wearable electronic device 401 may display another screen distinguished from the screen 501 via the display 420. The other screen distinguished from the screen 501 may include another visual object for providing functions for changing the setting of the wrist-wearable electronic device 401.

According to an embodiment, the wrist-wearable electronic device 401 may display a screen 502 via the display 420, in response to receiving a user input while displaying the screen 500. The user input may cause the screen 500 to be scrolled in the first direction. The screen 502 may include content for informing a user of information. The screen 502 may be referred to as a notification page. For example, the content may include summary information of a message, summary information of an e-mail, and/or notification information of an application. The wrist-wearable electronic device 401 may execute a function related to the content based on receiving an input for the content. For example, the wrist-wearable electronic device 401 may display the entire details of the content via the display 420, in response to receiving the input for the content. For example, the wrist-wearable electronic device 401 may display, via the display, a user interface 420 capable of transmitting an answer to a message (or email), in response to receiving an input for summary information of the message (or email). For example, the wrist-wearable electronic device 401 may execute an application in response to receiving an input for a notification of the corresponding application.

According to an embodiment, the wrist-wearable electronic device 401 may receive an input causing the screen 502 to be scrolled in a second direction perpendicular to the first direction while displaying the screen 502. In response to receiving the input causing the screen 502 to be scrolled in the second direction perpendicular to the first direction, the wrist-wearable electronic device 401 may display another screen distinguished from the screen 502 via the display 420. The other screen distinguished from the screen 502 may indicate content different from the content displayed on the screen 502.

According to an embodiment, the wrist-wearable electronic device 401 may display at least a portion of a screen 503 via the display 420, in response to receiving a user input while displaying the screen 500. The screen 503 may include a visual object corresponding to an application of the wrist-wearable electronic device 401. The screen 503 may be referred to as an application page. The wrist-wearable electronic device 401 may receive an input for a visual object while displaying at least a portion of the screen 503. In response to receiving the input for the visual object, the wrist-wearable electronic device 401 may execute an application corresponding to the visual object.

According to an embodiment, the wrist-wearable electronic device 401 may receive an input for moving a contact point in a direction, while displaying a first portion of the screen 503. In response to receiving the input for moving a contact point in a direction, the wrist-wearable electronic device 401 may display a second portion of the screen 503 via the display 420. For example, the wrist-wearable electronic device 401 may display a different screen from the previous screen (e.g., the first portion of the screen 503) by displaying the second portion of the screen 503 via the display 420. For example, the wrist-wearable electronic device 401 may display, via the display 420, a scroll animation in which the screen 503 is scrolled, in response to receiving the input for moving a contact point in a direction.

According to an embodiment, the wrist-wearable electronic device 401 may display a screen 504 via the display 420, in response to receiving a user input while displaying the screen 500. The user input may cause the screen 500 to be scrolled in the first direction. The screen 504 may be referred to as a tile (or a tile page). The tile may include information on functions of the wrist-wearable electronic device 401. The tile may include information on an application. The tile may include a widget of an application. For example, the screen 504 may include information of an exercise application. For example, the screen 504 may represent information on the number of steps of the user, information on an activity time of the user, and/or information on activity calories of the user.

According to an embodiment, the wrist-wearable electronic device 401 may receive an input causing the screen 504 to be scrolled in a second direction perpendicular to the first direction, while displaying the screen 504. In response to receiving the input causing the screen 504 to be scrolled in the second direction perpendicular to the first direction, the wrist-wearable electronic device 401 may display, via the display 420, other exercise information different from the information of the exercise application displayed on the screen 504. For example, the other exercise information may include yesterday's exercise information.

According to an embodiment, the wrist-wearable electronic device 401 may display, via the display 420, a screen 505, in response to receiving an input causing the screen 504 to be scrolled in the first direction while displaying the screen 504. For example, the screen 505 may be displayed as a tile including information on a weather application. For example, the screen 505 may include temperature information of a specified area and/or humidity information of the specified area.

FIG. 6 illustrates an example of an angle 610 between a wrist-wearable electronic device 401 and a finger-wearable electronic device 402 according to an embodiment.

Referring to FIG. 6, in a state 601 and a state 602, the wrist-wearable electronic device 401 and the finger-wearable electronic device 402 may be connected to each other. For example, the wrist-wearable electronic device 401 and the finger-wearable electronic device 402 may be wirelessly connected to each other. The wrist-wearable electronic device 401 may obtain information related to the angle 610 between the wrist-wearable electronic device 401 and the finger-wearable electronic device 402, based on sensor data obtained through a sensor (e.g., the sensor 440). For example, the angle 610 may include an angle between the wrist-wearable electronic device 402 and an axis directed in a direction perpendicular to a strap (e.g., the fastening members 250 and 260) of the wrist-wearable electronic device 401. For example, the angle 610 may include an angle between an axis directed in a direction perpendicular to the strap of the wrist-wearable electronic device 401 and an axis directed in a direction corresponding to a finger wearing the finger-wearable electronic device 402. For example, the axis directed in the direction perpendicular to the strap of the wrist-wearable electronic device 401 may include a center point of a display (e.g., the display 420).

The wrist-wearable electronic device 401 may obtain first sensor data through the sensor 440. For example, the first sensor data may include posture information of the wrist-wearable electronic device 401 and/or orientation information of the wrist-wearable electronic device 401. The finger-wearable electronic device 402 may obtain second sensor data through a sensor (e.g., the sensor 480). For example, the second sensor data may include posture information of the finger-wearable electronic device 402 and/or orientation information of the finger-wearable electronic device 402. The finger-wearable electronic device 402 may transmit the second sensor data to the wrist-wearable electronic device 401 through communication circuitry (e.g., the communication circuitry 470). The wrist-wearable electronic device 401 may receive the second sensor data from the finger-wearable electronic device 402 through the communication circuitry 430. As a non-limiting example, the wrist-wearable electronic device 401 may receive the second sensor data from the finger-wearable electronic device 402 based on a communication protocol such as Bluetooth, BLE, and/or UWB. The wrist-wearable electronic device 401 may obtain information related to the angle 610 between the wrist-wearable electronic device 401 and the finger-wearable electronic device 402 by using the first sensor data and the second sensor data.

According to an embodiment, the wrist-wearable electronic device 401 may obtain information related to the angle 610 between the wrist-wearable electronic device 401 and the finger-wearable electronic device 402 by using an ultra-wideband (UWB) communication technology. The UWB may be capable of measuring (or identifying) a position of an external object (e.g., the finger-wearable electronic device 402) and/or a posture of the external object, by using an ultra-wideband signal. The wrist-wearable electronic device 401 may use the UWB communication technology through communication circuitry (e.g., the communication circuitry 430). The wrist-wearable electronic device 401 may transmit an ultra-wideband signal to the finger-wearable electronic device 402 via the communication circuitry 430. The wrist-wearable electronic device 401 may receive a reflected ultra-wideband signal through the communication circuitry 430. The wrist-wearable electronic device 401 may obtain location information of the finger-wearable electronic device 402 and information related to the angle 610 between the wrist-wearable electronic device 401 and the finger-wearable electronic device 402, by analyzing the transmitted ultra-wideband signal and the received ultra-wideband signal.

According to an embodiment, the wrist-wearable electronic device 401 may obtain first distance information between the wrist-wearable electronic device 401 and the finger-wearable electronic device 402 by using the UWB communication technology. The wrist-wearable electronic device 401 may obtain second distance information between the wrist-wearable electronic device 401 and an external object (e.g., a body part of the user) by using the UWB communication technology. The finger-wearable electronic device 402 may obtain third distance information between the finger-wearable electronic device 402 and an external object (e.g., a body part of the user) by using the UWB communication technology. The finger-wearable electronic device 402 may transmit the third distance information to the wrist-wearable electronic device 401 via communication circuitry (e.g., the communication circuitry 470). The wrist-wearable electronic device 401 may obtain information related to the angle 610 between the wrist-wearable electronic device 401 and the finger-wearable electronic device 402, based on the first distance information, the second distance information, and the third distance information. For example, the wrist-wearable electronic device 401 may use a triangulation method.

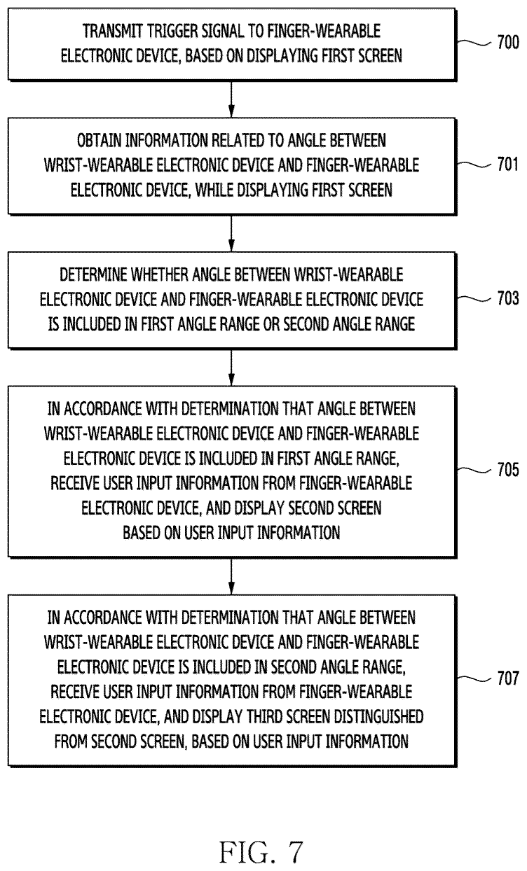

The wrist-wearable electronic device 401 may determine whether the angle 610 is included in one of a first angle range 611 and a second angle range 612 (i.e., whether the angle 610 is within the first angle range 611 or within the second angle range 612), based on the information related to the angle 610. The first angle range 611 and the second angle range 612 may be set by a user. In the state 601, the wrist-wearable electronic device 401 may determine that the angle 610 is included in the first angle range 611. In the state 602, the wrist-wearable electronic device 401 may determine that the angle 610 is included in the second angle range 612. In the state 601 and the state 602, the wrist-wearable electronic device 401 may recognize the same user input information differently. For example, a method of recognizing user input information of the wrist-wearable electronic device 401 differently will be described and exemplified with reference to FIG. 7.

FIG. 7 illustrates an example of operations of a wrist-wearable electronic device (e.g., the wrist-wearable electronic device 401) that displays a changed screen based on user input information according to an embodiment. Each operation may be performed sequentially, but is not necessarily performed sequentially. For example, a sequence of each operation may be changed, and at least two operations may be performed in parallel.

Referring to FIG. 7, in operation 700, the wrist-wearable electronic device 401 (e.g., the at least one processor 400) may transmit a trigger signal to a finger-wearable electronic device (e.g., the finger-wearable electronic device 402) through communication circuitry (e.g., the communication circuitry 430), based on displaying a first screen (e.g., the screen 500) via a display (e.g., the display 420).

According to an embodiment, the first screen may include a screen that may be changed (or switched) to another screen (e.g., the screen 501, the screen 502, at least a portion of the screen 503, the screen 504, the screen 505, a second screen to be described later, and a third screen to be described later) in accordance with the satisfaction of a condition of the wrist-wearable electronic device 401 (e.g., reception of a user input). For example, the wrist-wearable electronic device 401 may change a screen displayed via the display 420 from a first screen to another screen, based on receiving a user input (e.g., an input for moving a contact point in a direction) while displaying the first screen. As a non-limiting example, the first screen may include a screen capable of displaying a scroll animation (e.g., an animation in which visual objects are scrolled) in accordance with a user input.

According to an embodiment, the trigger signal may be referred to as a signal for triggering the finger-wearable electronic device 402 to obtain user input information via a sensor (e.g., the sensor 480). For example, in response to receiving the trigger signal, the finger-wearable electronic device 402 may change a state of the finger-wearable electronic device 402 from a first state (or a standby state) for low power consumption to a second state for obtaining user input information via the sensor 480. For example, in the second state, the finger-wearable electronic device 402 may obtain user input information via the sensor 480. For example, the finger-wearable electronic device 402 may transmit the obtained user input information to the wrist-wearable electronic device 401 through communication circuitry (e.g., the communication circuitry 470).

As a non-limiting example, according to an embodiment, the wrist-wearable electronic device 401 may transmit a trigger signal to the finger-wearable electronic device 402 via the communication circuitry 430, based on activation of the display 420. For example, the wrist-wearable electronic device 401 may transmit a trigger signal to the finger-wearable electronic device 402 via the communication circuitry 430, based on a connection (e.g., wireless connection) with the finger-wearable electronic device 402 while the display 420 is in an activation state. The activation state of display 420 may be referred to as a state for displaying a screen (e.g., including content) via the display 420. The activation state of the display 420 may be distinguished from an always on display (AOD) state. The activation state of the display 420 may be distinguished from a turn-off state. The activation state of the display 420 may be distinguished from a standby state for low power consumption. The wrist-wearable electronic device 401 may change a state of the display 420 from the standby state (or the AOD state or the turn-off state) to the activation state, according to receiving a designated input (e.g., an input for a physical button, a touch input to the display 420, and/or a gesture input of raising a wrist).

According to another embodiment, the wrist-wearable electronic device 401 may transmit a trigger signal to the finger-wearable electronic device 402 via the communication circuitry 430, based on determining that the wrist-wearable electronic device 401 is worn on an external object (e.g., a wrist of the user).

In operation 701, the wrist-wearable electronic device 401 (e.g., the at least one processor 400) may obtain information related to an angle (e.g., the angle 610) between the wrist-wearable electronic device 401 and the finger-wearable electronic device 402, based on sensor data obtained via a sensor (e.g., the sensor 440) while displaying a first screen (e.g., the screen 500) via a display (e.g., the display 420). The wrist-wearable electronic device 401 and the finger-wearable electronic device 402 may be wirelessly connected to each other. The descriptions of FIG. 6 may be referenced for an operation in which the wrist-wearable electronic device 401 obtains information related to an angle (e.g., the angle 610) between the wrist-wearable electronic device 401 and the finger-wearable electronic device 402 based on sensor data.

According to an embodiment, the wrist-wearable electronic device 401 may obtain information related to an angle (e.g., the angle 610) between the wrist-wearable electronic device 401 and the finger-wearable electronic device 402, while displaying a first screen (e.g., the screen 500) via a display (e.g., the display 420). For example, the wrist-wearable electronic device 401 may display the first screen via the display 420, in response to receiving an input for a designated button (e.g., a home button, a physical button). For example, the wrist-wearable electronic device 401 may identify a wake gesture input (e.g., a gesture of raising a wrist) using sensor data obtained via a sensor (e.g., the sensor 440). The wrist-wearable electronic device 401 may display the first screen via the display 420 in response to identifying the wake gesture input.

According to an embodiment, the first screen may be distinguished from a screen displaying visual content for always on display (AOD). While the wrist-wearable electronic device 401 displays the first screen, the at least one processor 400 may be in a wake-up state.

In operation 703, based on information related to an angle (e.g., the angle 610) between the wrist-wearable electronic device 401 and the finger-wearable electronic device 402, the wrist-wearable electronic device 401 (e.g., the at least one processor 400) may determine whether the angle 610 is included in a first angle range (e.g., the angle 611) or a second angle range (e.g., the second angle range 612). The second angle range 612 may be distinguished from the first angle range 611.

In operation 705, the wrist-wearable electronic device 401 (e.g., the at least one processor 400) may receive, from the finger-wearable electronic device 402 via communication circuitry (e.g., the communication circuitry 430), user input information for the finger-wearable electronic device 402, in accordance with a determination that an angle (e.g., the angle 610) between the wrist-wearable electronic device 401 and the finger-wearable electronic device 402 is included in a first angle range (e.g., the first angle range 611). The wrist-wearable electronic device 401 (e.g., the at least one processor 400) may display, via a display (e.g., the display 420), a second screen (e.g., the screen 502, the screen 504, and the screen 505), based on the user input information, in accordance with a determination that an angle (e.g., the angle 610) between the wrist-wearable electronic device 401 and the finger-wearable electronic device 402 is included in a first angle range (e.g., the first angle range 611). For example, the second screen may be a screen changed from the first screen. For example, the wrist-wearable electronic device 401 may determine that an angle (e.g., angle 610) between the wrist-wearable electronic device 401 and the finger-wearable electronic device 402 is included in a first angle range (e.g., the first angle range 611), in the state 601 of FIG. 6.

According to an embodiment, while changing the first screen to the second screen, the wrist-wearable electronic device 401 may display, via a display (e.g., the display 420), a first scroll animation in which the first screen moves along a first axis parallel to a strap (e.g., the fastening members 250 and 260) of the wrist-wearable electronic device 401. For example, the first scroll animation may include scrolling up of the first screen and/or scrolling down of the first screen. For example, a velocity of the first scroll animation may be set to be faster, as an angle (e.g., the angle 610) between the wrist-wearable electronic device 401 and the finger-wearable electronic device 402 increases.

According to an embodiment, the finger-wearable electronic device 402 may transmit user input information for the finger-wearable electronic device 402 to the wrist-wearable electronic device 401 via communication circuitry (e.g., the communication circuitry 470). The user input information for the finger-wearable electronic device 402 may include sensor data obtained via a sensor (e.g., the sensor 480) of the finger-wearable electronic device 402. For example, the sensor data may include scroll information obtained via a touch sensor. The scroll information may indicate a movement of a user's body (e.g., a finger) in contact with the touch sensor. The scroll information may indicate a velocity of the user's body in contact with the touch sensor, a moving direction of the user's body in contact with the touch sensor, and/or a moving distance of the user's body in contact with the touch sensor. For example, the sensor data may include gyro information obtained via the IMU sensor. The gyro information may include a parameter related to a rotation of the finger-wearable electronic device 402. For example, the gyro information may indicate a rotation angle of the finger-wearable electronic device 402, an angular velocity of the finger-wearable electronic device 402, and/or a rotation direction (e.g., clockwise or counterclockwise) of the finger-wearable electronic device 402.

In operation 707, the wrist-wearable electronic device 401 (e.g., the at least one processor 400) may receive user input information for the finger-wearable electronic device 402 from the finger-wearable electronic device 402 via communication circuitry (e.g., the communication circuitry 430), in accordance with a determination that an angle (e.g., the angle 610) between the wrist-wearable electronic device 401 and the finger-wearable electronic device 402 is included in a second angle range (e.g., the second angle range 612). The wrist-wearable electronic device 401 (e.g., the at least one processor 400) may display a third screen (e.g., the screen 501, the screen 503) via a display (e.g., the display 420) based on user input information, in accordance with a determination that an angle (e.g., the angle 610) between the wrist-wearable electronic device 401 and the finger-wearable electronic device 402 is included in a second angle range (e.g., the second angle range 612). The third screen may be a screen changed from the first screen. The third screen may be a screen distinguished from the second screen. For example, in the state 602 of FIG. 6, the wrist-wearable electronic device 401 may determine that an angle (e.g., the angle 610) between the wrist-wearable electronic device 401 and the finger-wearable electronic device 402 is included in a second angle range (e.g., the second angle range 612).

According to an embodiment, the wrist-wearable electronic device 401 may display, via a display (e.g., the display 420), a second scroll animation in which the first screen moves along a second axis perpendicular to the first axis parallel to a strap of the wrist-wearable electronic device 401, while changing the first screen to the third screen. For example, the second scroll animation may include a scroll left of the first screen and/or a scroll light of the first screen. For example, a velocity of the second scroll animation may be set to be faster as an angle (e.g., the angle 610) between the wrist-wearable electronic device 401 and the finger-wearable electronic device 402 increases.

According to an embodiment, the finger-wearable electronic device 402 may transmit user input information for the finger-wearable electronic device 402 to the wrist-wearable electronic device 401 via communication circuitry (e.g., the communication circuitry 470). The user input information for the finger-wearable electronic device 402 may include sensor data obtained via a sensor (e.g., the sensor 480) of the finger-wearable electronic device 402. The descriptions for operation 705 may be referenced for the sensor data.

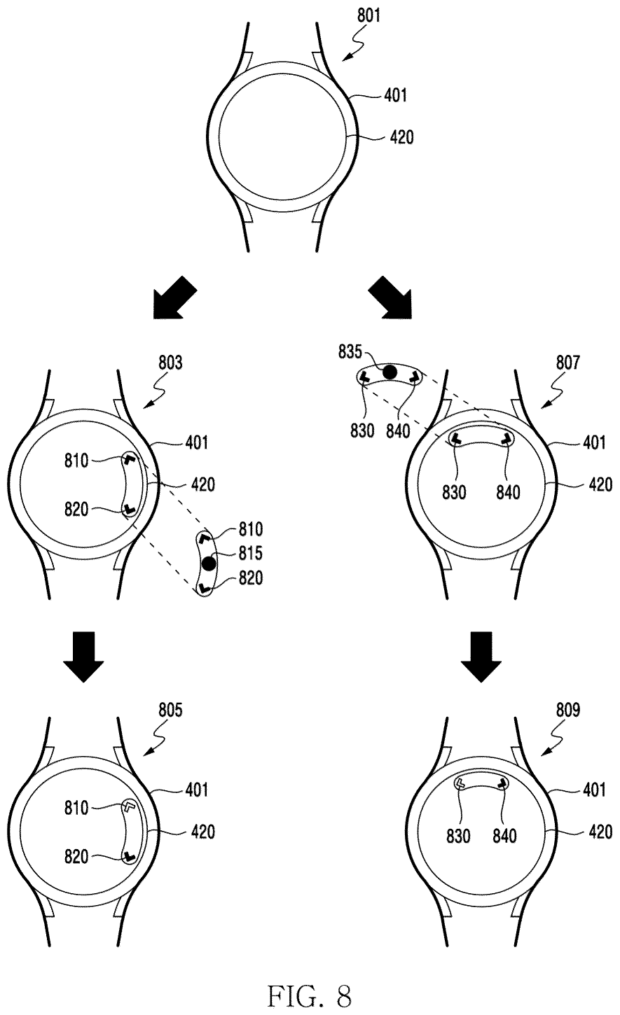

FIG. 8 illustrates an example of a wrist-wearable electronic device 401 that displays visual objects in accordance with whether an angle (e.g., the angle 610) between the wrist-wearable electronic device 401 and a finger-wearable electronic device (e.g., the finger-wearable electronic device 402) is included in a first angle range (e.g., the first angle range 611) or a second angle range (e.g., the second angle range 612) according to an embodiment.

Referring to FIG. 8, in a state 801, the wrist-wearable electronic device 401 may display a screen via a display (e.g., the display 420). The wrist-wearable electronic device 401 may transmit a trigger signal to a finger-wearable electronic device (e.g., the finger-wearable electronic device 402) via communication circuitry (e.g., the communication circuitry 430), based on displaying a screen (e.g., the screen 500, the first screen of FIG. 7) via the display 420. The trigger signal may be referred to as a signal for triggering the finger-wearable electronic device 402 to obtain user input information via a sensor (e.g., the sensor 480). The descriptions for operation 700 in FIG. 7 may be referenced for the trigger signal. For example, after transmitting the trigger signal, the wrist-wearable electronic device 401 may determine whether the angle 610 is included in the first angle range 611 or the second angle range 612. However, embodiments are not limited thereto. After determining whether the angle 610 is included in the first angle range 611 or the second angle range 612, the wrist-wearable electronic device 401 may transmit the trigger signal to the finger-wearable electronic device 402.

According to an embodiment, the wrist-wearable electronic device 401 may change from the state 801 to a state 803, in accordance with a determination that the angle 610 is included in the first angle range 611. For example, after transmitting the trigger signal, the wrist-wearable electronic device 401 may change from the state 801 to state 803 in accordance with a determination that the angle 610 is included in the first angle range 611.

According to an embodiment, the finger-wearable electronic device 402 may identify an external object (e.g., the user's finger) in contact with the finger-wearable electronic device 402 via a sensor (e.g., the sensor 480, touch sensor). The finger-wearable electronic device 402 may transmit a start signal to the wrist-wearable electronic device 401 via communication circuitry (e.g., the communication circuitry 470), in response to identifying an external object (e.g., the user's finger) in contact with the finger-wearable electronic device 402. According to another embodiment, the finger-wearable electronic device 402 may transmit a start signal to the wrist-wearable electronic device 401 via the communication circuitry 470, based on identifying, via the sensor 480, a rotation greater than or equal to a threshold angle. After transmitting the start signal, the finger-wearable electronic device 402 may obtain user input information via the sensor 480. The start signal may be referred to as a signal for notifying the wrist-wearable electronic device 401 of obtainment of the user input information and transmission of the user input information. According to an embodiment, the wrist-wearable electronic device 401 may determine whether the angle 610 is included in the first angle range 611 or the second angle range 612, based on receiving the start signal from the finger-wearable electronic device 402. However, embodiments are not limited thereto. After it is determined whether the angle 610 is included in the first angle range 611 or the second angle range 612, the wrist-wearable electronic device 401 may receive the start signal from the finger-wearable electronic device 402. In response to receiving the start signal, the wrist-wearable electronic device 401 may change from the state 801 to the state 803 in accordance with a determination that the angle 610 is included in the first angle range 611.

In the state 803, the wrist-wearable electronic device 401 may display, via the display 420, a visual object 810 and/or a visual object 820. The wrist-wearable electronic device 401 may overlappingly display the visual object 810 and/or the visual object 820 on the screen. The visual object 810 may be an indicator for guiding scrolling of a screen in a first direction of an axis parallel to a strap (e.g., the fastening members 250 and 260) of the wrist-wearable electronic device 401. The visual object 820 may be an indicator for guiding scrolling of a screen in a second direction opposite to the first direction.

According to an embodiment, the wrist-wearable electronic device 401 may display, via the display 420, the visual object 810, a visual object 815, and/or the visual object 820. The visual object 815 may be moved to correspond to a direction in which a screen is scrolled, while the screen is scrolled according to a user input. For example, when the screen is scrolled in a direction guided by the visual object 810, the wrist-wearable electronic device 401 may move the visual object 815 to be adjacent to the visual object 810 among the visual object 810 and the visual object 820. For example, when the screen is scrolled in a direction guided by the visual object 820, the wrist-wearable electronic device 401 may move the visual object 815 to be adjacent to the visual object 820 among the visual object 810 and the visual object 820.

The wrist-wearable electronic device 401 may change from the state 803 to a state 805, in response to identifying that the scrolling of the screen in a direction in which the screen is guided by the visual object 810 is impossible. For example, the wrist-wearable electronic device 401 may identify that the scrolling of the screen is impossible, by identifying that the scrolling of the screen has failed a predetermined number of times.

In the state 805, the wrist-wearable electronic device 401 may display, via the display 420, a visual effect for the visual object 810. For example, the visual effect may include an effect of reducing saturation of the visual object 810. For example, the visual effect may include a dim effect for the visual object 810. For example, the visual effect may include an effect of increasing transparency for the visual object 810. For example, the visual effect may include a blur effect for the visual object 810. For example, the visual effect may include an effect of changing a color of the visual object 810. However, embodiments are not limited thereto.

According to an embodiment, the wrist-wearable electronic device 401 may determine a failure of an input, in response to identifying that changing of the screen is impossible, in accordance with a determination that the angle 610 is included in the first angle range 611. For example, the wrist-wearable electronic device 401 may determine a failure of an input, in response to identifying that scrolling of the screen in a direction in which the screen is guided by the visual object 810 is impossible. The wrist-wearable electronic device 401 may execute a function for correcting an operation for determining the angle 610, based on identifying the number of failures of the input being greater than a reference number. The reference number may be set in the wrist-wearable electronic device 401 by a user. In response to identifying the number of failures of the input being greater than the reference number, the wrist-wearable electronic device 401 may output a notification for suggesting correction of an operation for determining the angle 610. In response to identifying the number of failures of the input being greater than the reference number, the wrist-wearable electronic device 401 may display, via the display 420, a user interface for correcting an operation for determining the angle 610. The wrist-wearable electronic device 401 may perform correction of an operation for determining the angle 610 while displaying the user interface.

In the state 801, the wrist-wearable electronic device 401 may display a screen via the display 420. The wrist-wearable electronic device 401 may change from the state 801 to a state 807, in accordance with a determination that the angle 610 is included in the second angle range 612. For example, after transmitting the trigger signal, the wrist-wearable electronic device 401 may change from the state 801 to the state 807 in accordance with a determination that the angle 610 is included in the second angle range 612.

As a non-limiting example, the wrist-wearable electronic device 401 may determine whether the angle 610 is included in the first angle range 611 or the second angle range 612, based on receiving a start signal from the finger-wearable electronic device 402. However, embodiments are not limited thereto. After it is determined whether the angle 610 is included in the first angle range 611 or the second angle range 612, the wrist-wearable electronic device 401 may receive the start signal from the finger-wearable electronic device 402. In response to receiving the start signal, the wrist-wearable electronic device 401 may change from the state 801 to the state 807, in accordance with a determination that the angle 610 is included in the second angle range 612.

In the state 807, the wrist-wearable electronic device 401 may display a visual object 830 and/or a visual object 840 via the display 420. The wrist-wearable electronic device 401 may overlappingly display the visual object 810 and/or the visual object 820 on a screen. The visual object 830 may be an indicator for guiding scrolling of the screen in a third direction of an axis perpendicular to the strap of the wrist-wearable electronic device 401. The third direction may be perpendicular to the direction guided by the visual object 810. The visual object 820 may be an indicator for guiding scrolling of the screen in a fourth direction opposite to the third direction.

According to an embodiment, the wrist-wearable electronic device 401 may display, via the display 420, the visual object 830, a visual object 835, and/or the visual object 840. The visual object 835 may be moved to correspond to a direction in which a screen is scrolled, while the screen is scrolled according to a user input. For example, when the screen is scrolled in a direction guided by the visual object 830, the wrist-wearable electronic device 401 may move the visual object 835 to be adjacent to the visual object 830 among the visual object 830 and the visual object 840. For example, when the screen is scrolled in a direction guided by the visual object 840, the wrist-wearable electronic device 401 may move the visual object 835 to be adjacent to the visual object 840 among the visual object 830 and the visual object 840.

The wrist-wearable electronic device 401 may change from the state 807 to a state 809, in response to identifying that scrolling of the screen in a direction in which the screen is guided by the visual object 830 is impossible.

In the state 809, the wrist-wearable electronic device 401 may display a visual effect for the visual object 830 via the display 420. The descriptions of the visual effect for the visual object 810 exemplified in the state 805 may be referenced for the visual effect for the visual object 830. For example, the visual effect may include an effect of reducing saturation of the visual object 830. For example, the visual effect may include a dim effect for the visual object 830. For example, the visual effect may include an effect of increasing transparency for the visual object 830. For example, the visual effect may include a blur effect for the visual object 830. For example, the visual effect may include an effect of changing a color of the visual object 830. However, embodiments are not limited thereto.

In FIG. 8, it has been illustrated that the wrist-wearable electronic device 401 may change from the state 801 to the state 803, but this is for convenience of explanation only and embodiments are not limited thereto. The wrist-wearable electronic device 401 may change from the state 807 to the state 803, in accordance with a determination that the angle 610 is included in the first angle range 611. The wrist-wearable electronic device 401 may change from the state 803 to the state 807, in accordance with a determination that the angle 610 is included in the second angle range 612.

According to an embodiment, the wrist-wearable electronic device 401 may change from the state 807 to the state 803, in response to identifying that the angle 610 is changed from within the second angle range 612 to within the first angle range 611. The wrist-wearable electronic device 401 may cease or refrain from displaying the visual object 830 and/or the visual object 840. The wrist-wearable electronic device 401 may display, via the display 420, the visual object 810 and/or the visual object 820.

The wrist-wearable electronic device 401 may change from the state 803 to the state 807, in response to identifying that the angle 610 is changed from within the first angle range 611 to within the second angle range 612. The wrist-wearable electronic device 401 may cease or refrain from displaying the visual object 810 and/or the visual object 820. The wrist-wearable electronic device 401 may display, via the display 420, the visual object 830 and/or the visual object 840.

According to an embodiment, the wrist-wearable electronic device 401 may determine a change of a mode, in response to identifying that the angle 610 is changed from within the first angle range 611 to within the second angle range 612. After determining that the angle 610 is included in the first angle range 611, the wrist-wearable electronic device 401 may determine a change of a mode, based on identifying that the angle 610 is included within the second angle range 612. The wrist-wearable electronic device 401 may determine a change of a mode, in response to identifying that the angle 610 is changed from within the second angle range 612 to within the first angle range 611. After determining that the angle 610 is included in the second angle range 612, the wrist-wearable electronic device 401 may determine a change of a mode, based on identifying that the angle 610 is included within the first angle range 611. The wrist-wearable electronic device 401 may execute a function for correcting an operation for determining the angle 610, based on identifying the number of changes of the mode being greater than a reference number during a reference time. The reference time and the reference number may be set by the user in the wrist-wearable electronic device 401. In response to identifying the number of changes of the mode being greater than the reference number during the reference time, the wrist-wearable electronic device 401 may output a notification for suggesting correction of an operation for determining the angle 610. The wrist-wearable electronic device 401 may display, via the display 420, a user interface for correcting an operation for determining the angle 610, in response to identifying the number of changes of the mode being greater than the reference number during the reference time. The wrist-wearable electronic device 401 may perform correction of an operation for determining the angle 610 while displaying the user interface.

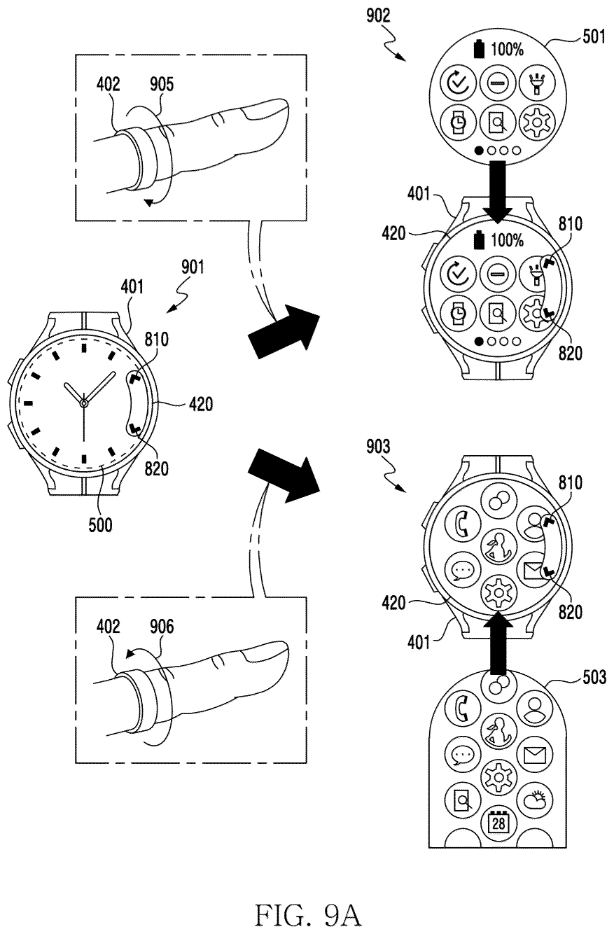

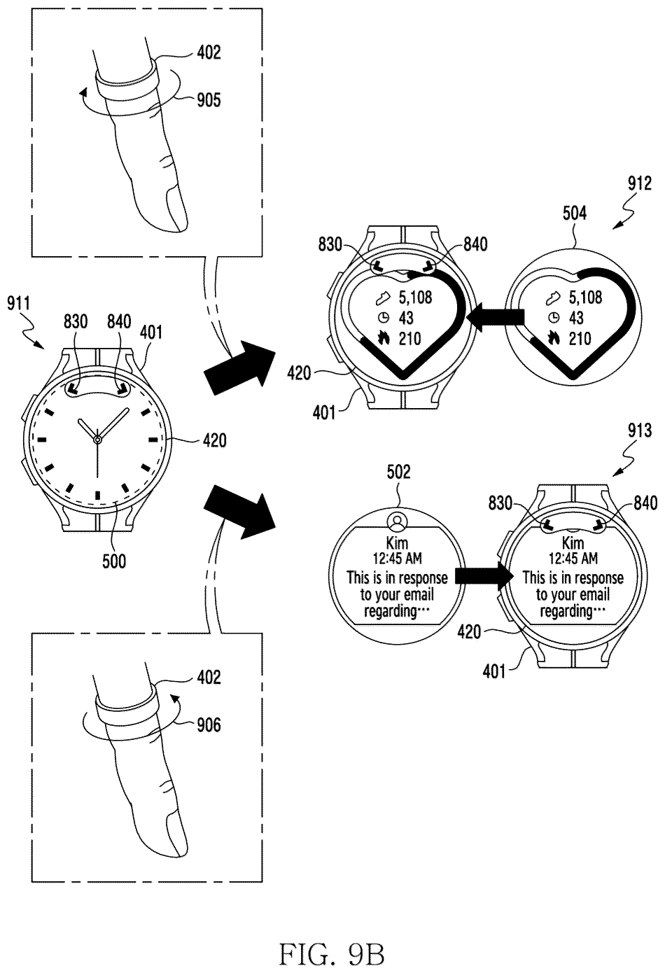

FIGS. 9A and 9B illustrate an example of a wrist-wearable electronic device 401 that displays a changed screen, based on user input information received from a finger-wearable electronic device 402 according to an embodiment.

Referring to FIG. 9A, a state 901 may be described as a state in which an angle (e.g., the angle 610) between the wrist-wearable electronic device 401 and the finger-wearable electronic device 402 is included in a first angle range (e.g., the first angle range 611). The wrist-wearable electronic device 401 may determine that the angle 610 is included in the first angle range 611. For example, in the state 901, the wrist-wearable electronic device 401 may be in the state 601 of FIG. 6. In the state 901, the wrist-wearable electronic device 401 may display a screen 500 via a display 420. The wrist-wearable electronic device 401 may display, via the display 420, a visual object 810 and/or a visual object 820. The wrist-wearable electronic device 401 may receive user input information for the finger-wearable electronic device 402 from the finger-wearable electronic device 402 via communication circuitry (e.g., the communication circuitry 430). For example, the finger-wearable electronic device 402 may generate user input information by using sensor data obtained via a sensor (e.g., the sensor 480). The wrist-wearable electronic device 401 may change from the state 901 to a state 902 or a state 903, based on the received user input information.

According to an embodiment, the user input information may include gyro information indicating that the finger-wearable electronic device 402 rotates in a first direction 905. The first direction 905 may be a clockwise direction around an axis directed from the finger-wearable electronic device 402 worn on a finger of a user's left hand to a fingertip. The wrist-wearable electronic device 401 may change from the state 901 to the state 902, based on gyro information indicating that the finger-wearable electronic device 402 rotates in the first direction 905.

According to an embodiment, the user input information may include scroll information obtained via a touch sensor of the finger-wearable electronic device 402 worn on a finger of the user's left hand. The touch sensor may be disposed on a surface of the finger-wearable electronic device 402 facing the outside of a housing. The scroll information may indicate that the surface is scrolled in the first direction 905 by a user's body (e.g., a finger). The wrist-wearable electronic device 401 may change the state 901 to the state 902, based on scroll information indicating that the surface is scrolled in the first direction 905 by a user's body (e.g., a finger).

In the state 902, the wrist-wearable electronic device 401 may display a screen 501 via the display 420. While changing from the state 901 to the state 902, the wrist-wearable electronic device 401 may display, via the display 420, a scroll animation in which the screen 500 and/or the screen 501 moves in a direction corresponding to the visual object 820. The direction corresponding to the visual object 820 may be a direction of an axis parallel to a strap of the wrist-wearable electronic device 401.

According to an embodiment, the user input information may include gyro information indicating that the finger-wearable electronic device 402 rotates in a second direction 906. The second direction 906 may be a counterclockwise direction around an axis directed from the finger-wearable electronic device 402 worn on a finger of a user's left hand to a fingertip. The second direction 906 may be opposite to the first direction 905. The wrist-wearable electronic device 401 may change the state 901 to the state 903, based on gyro information indicating that the finger-wearable electronic device 402 rotates in the second direction 906.

According to an embodiment, the user input information may include scroll information obtained via a touch sensor of the finger-wearable electronic device 402 worn on a finger of the user's left hand. The touch sensor may be disposed on a surface of the finger-wearable electronic device 402 facing the outside of the housing. The scroll information may indicate that the surface is scrolled in the second direction 906 by a user's body (e.g., a finger). The wrist-wearable electronic device 401 may change the state 901 to the state 903, based on scroll information indicating that the surface is scrolled in the second direction 905 by a user's body (e.g., a finger).

In the state 903, the wrist-wearable electronic device 401 may display at least a portion of the screen 503 via the display 420. While changing from the state 901 to the state 903, the wrist-wearable electronic device 401 may display, via the display 420, a scroll animation in which the screen 500 and/or the screen 503 move in a direction corresponding to the visual object 810. The direction corresponding to the visual object 810 may be opposite to the direction corresponding to the visual object 820.

In the present disclosure, for convenience of explanation, the finger-wearable electronic device 402 in a state of being worn on the user's left hand is illustrated. As a non-limiting example, when the finger-wearable electronic device 402 is worn on the user's right hand, the first direction 905 may be a counterclockwise direction around an axis directed to a fingertip. As a non-limiting example, when the finger-wearable electronic device 402 is worn on the user's right hand, the second direction 906 may be a clockwise direction around an axis directed to the fingertip.

Referring to FIG. 9B, a state 911 may be described as a state in which an angle (e.g., the angle 610) between the wrist-wearable electronic device 401 and the finger-wearable electronic device 402 is included in a second angle range (e.g., the second angle range 612). The wrist-wearable electronic device 401 may determine that the angle 610 is included in the second angle range 612. For example, in the state 911, the wrist-wearable electronic device 401 may be in the state 602 of FIG. 6. In the state 911, the wrist-wearable electronic device 401 may display the screen 500 via the display 420. The wrist-wearable electronic device 401 may display, via the display 420, the visual object 830 and/or the visual object 840. The wrist-wearable electronic device 401 may receive user input information for the finger-wearable electronic device 402 from the finger-wearable electronic device 402 via communication circuitry (e.g., the communication circuitry 430). For example, the finger-wearable electronic device 402 may generate user input information by using sensor data obtained via a sensor (e.g., the sensor 480). The wrist-wearable electronic device 401 may change from the state 911 to a state 912 or a state 913 based on the received user input information.

According to an embodiment, the user input information may include gyro information indicating that the finger-wearable electronic device 402 rotates in a first direction 905. The first direction 905 may be a clockwise direction around an axis directed from the finger-wearable electronic device 402 worn on a finger of a user's left hand to a fingertip. The wrist-wearable electronic device 401 may change from the state 911 to the state 912, based on gyro information indicating that the finger-wearable electronic device 402 rotates in the first direction 905.

According to an embodiment, the user input information may include scroll information obtained via a touch sensor of the finger-wearable electronic device 402 worn on a finger of the user's left hand. The touch sensor may be disposed on a surface of the finger-wearable electronic device 402 facing the outside of a housing. The scroll information may indicate that the surface is scrolled by a user's body (e.g., a finger) in the first direction 905. The wrist-wearable electronic device 401 may change from the state 911 to the state 912, based on scroll information indicating that the surface is scrolled by a user's body (e.g., a finger) in the first direction 905.

In the state 912, the wrist-wearable electronic device 401 may display the screen 504 via the display 420. While changing from the state 911 to the state 912, the wrist-wearable electronic device 401 may display, via the display 420, a scroll animation in which the screen 500 and/or the screen 504 move in a direction corresponding to the visual object 830. The direction corresponding to the visual object 830 may be a direction of an axis perpendicular to a strap of the wrist-wearable electronic device 401.

According to an embodiment, the user input information may include gyro information indicating that the finger-wearable electronic device 402 rotates in a second direction 906. The second direction 906 may be a counterclockwise direction around an axis directed from the finger-wearable electronic device 402 worn on a finger of the user's left hand to a fingertip. The second direction 906 may be opposite to the first direction 905. The wrist-wearable electronic device 401 may change the state 911 to the state 913, based on gyro information indicating that the finger-wearable electronic device 402 rotates in the second direction 906.

According to an embodiment, the user input information may include scroll information obtained via a touch sensor of the finger-wearable electronic device 402 worn on a finger of the user's left hand. The touch sensor may be disposed on a surface of the finger-wearable electronic device 402 facing the outside of a housing. The scroll information may indicate that the surface is scrolled by a user's body (e.g., a finger) in the second direction 906. The wrist-wearable electronic device 401 may change from the state 911 to the state 913, based on scroll information indicating that the surface is scrolled by a user's body (e.g., a finger) in the second direction 905.

In the state 913, the wrist-wearable electronic device 401 may display the screen 502 via the display 420. While changing from the state 911 to the state 913, the wrist-wearable electronic device 401 may display, via the display 420, a scroll animation in which the screen 500 and/or the screen 502 move in a direction corresponding to the visual object 840. The direction corresponding to the visual object 840 may be opposite to the direction corresponding to the visual object 830.

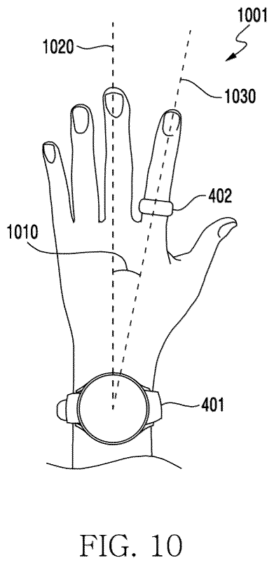

FIG. 10 illustrates an example of a wrist-wearable electronic device 401 that corrects an angle (e.g., the angle 610) between the wrist-wearable electronic device 401 and a finger-wearable electronic device 402 according to an embodiment.

Referring to FIG. 10, an example 1001 may represent a left hand of a user wearing the wrist-wearable electronic device 401 and the finger-wearable electronic device 402. A horizontal angle 1010 may be described as an angle between an axis 1020 and an axis 1030. The axis 1020 may be perpendicular to a strap (e.g., the fastening members 250 and 260) of the wrist-wearable electronic device 401. The axis 1020 may include a center point of a display (e.g., the display 420) of the wrist-wearable electronic device 401. The axis 1030 may be referred to as an axis extending from a center point of a display (e.g., the display 420) of the wrist-wearable electronic device 401 toward the finger-wearable electronic device 402. As a non-limiting example, the axis 1030 may include a center point of a donut-shaped housing of the finger-wearable electronic device 402.

In order to determine whether the angle 610 is included in a first angle range (e.g., the first angle range 611) or a second angle range (e.g., the second angle range 612), the wrist-wearable electronic device 401 may calculate or obtain the angle 610 using information related to the angle 610. The horizontal angle 1010 may be included in information related to the angle 610. The horizontal angle 1010 may differ according to a finger wearing the finger-wearable electronic device 402. The wrist-wearable electronic device 401 may perform correction of the horizontal angle 1010 to improve the quality of the angle 610. The wrist-wearable electronic device 401 may enhance accuracy of the calculated angle 610 by performing correction of the horizontal angle 1010. For example, the wrist-wearable electronic device 401 may perform correction of the horizontal angle 1010 so that a size of the horizontal angle 1010 converges to ‘0’.

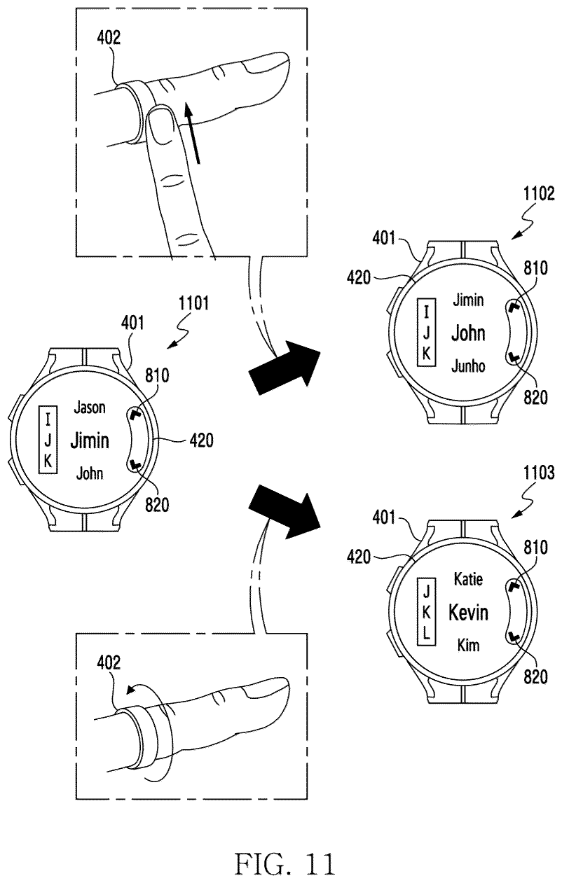

FIG. 11 illustrates an example of a wrist-wearable electronic device 401 that displays different types of scroll animation according to user input information according to an embodiment.

Referring to FIG. 11, in a state 1101, the wrist-wearable electronic device 401 may display, via the display 420 a screen including a list of visual objects. For example, the screen may include an execution screen of a contact application. The wrist-wearable electronic device 401 may receive user input information from the finger-wearable electronic device 402 via communication circuitry (e.g., the communication circuitry 430). The wrist-wearable electronic device 401 may determine whether the user input information includes scroll information (i.e., information from a touch sensor that indicates the user input slides along a surface of the finger-wearable electronic device 402) or gyro information (i.e., information from a touch sensor that indicates the finger-wearable electronic device 402 physically rotates (i.e., rotates around) the user's body (e.g., the finger)).

The wrist-wearable electronic device 401 may determine that the user input information includes scroll information. The wrist-wearable electronic device 401 may change from the state 1101 to a state 1102 in accordance with a determination that the user input information includes scroll information. The wrist-wearable electronic device 401 may display, via the display 420, a first scroll animation in which each of visual objects is scrolled, in accordance with a determination that the user input information includes scroll information. For example, the wrist-wearable electronic device 401 may display, via the display 420, a first scroll animation in which each (e.g., “Jason”, “Jimin”, “John”, and “Junho”) of visual objects starting with “J” are scrolled.

The wrist-wearable electronic device 401 may determine that the user input information includes gyro information. The wrist-wearable electronic device 401 may change the state 1101 to a state 1103, in accordance with a determination that the user input information includes gyro information. The wrist-wearable electronic device 401 may display, via the display 420, a second scroll animation in which each of groups of visual objects is scrolled, in accordance with a determination that the user input information includes gyro information. For example, the wrist-wearable electronic device 401 may display, via the display 420, a second scroll animation that is scrolled from a first group of visual objects starting with “J” to a second group of visual objects starting with “K”.

As a non-limiting example, the wrist-wearable electronic device 401 may display, via the display 420, a scroll animation in which visual objects are scrolled at a first velocity, in accordance with a determination that the user input information includes scroll information. The wrist-wearable electronic device 401 may display, via the display 420, a scroll animation in which visual objects are scrolled at a second velocity, in accordance with a determination that the user input information includes gyro information. The first velocity and the second velocity may be distinguished. For example, the second velocity may be faster than the first velocity.

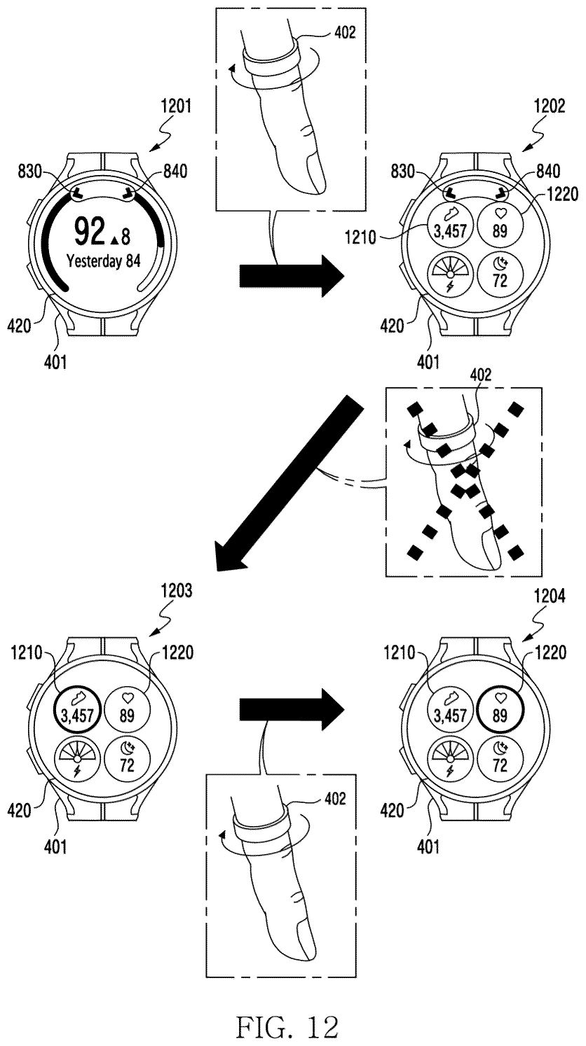

FIG. 12 illustrates an example of operations of a wrist-wearable electronic device 401 that provides a gesture mode according to an embodiment.

Referring to FIG. 12, in a state 1201, the wrist-wearable electronic device 401 may determine that an angle (e.g., the angle 610) between the wrist-wearable electronic device 401 and the finger-wearable electronic device 402 is included in a second angle range (e.g., the second angle range 612). The wrist-wearable electronic device 401 may display a visual object 830 and/or a visual object 840 via the display 420. The wrist-wearable electronic device 401 may change the state 1201 to a state 1202, based on user input information received from the finger-wearable electronic device 402.

In the state 1202, the wrist-wearable electronic device 401 may display, via the display 420, a screen including a visual object 1210 and/or a visual object 1220. The screen displayed in the state 1201 and the screen displayed in the state 1202 may be distinguished. The wrist-wearable electronic device 401 may receive an input for providing a gesture mode. The gesture mode may be described as a mode for recognizing a movement of a hand connected to a wrist wearing the wrist-wearable electronic device 401 as an input. While providing the gesture mode, the wrist-wearable electronic device 401 may obtain movement information of the hand via a sensor (e.g., the sensor 440). The wrist-wearable electronic device 401 may obtain or identify a gesture input of the hand using the movement information of the hand. The wrist-wearable electronic device 401 may execute a function corresponding to the gesture input. The gesture mode may be referred to as a mode that provides a universal gesture function.

According to an embodiment, an input for providing the gesture mode may include receiving user input information less than reference user input information from the finger-wearable electronic device 402 by the wrist-wearable electronic device 401. The reference user input information may be set in the wrist-wearable electronic device 401. For example, the reference user input information may be a threshold distance or a threshold angle. For example, the input for providing the gesture mode may include that reception of the user input information from the finger-wearable electronic device 402 is ceased for a predetermined period of time.

According to an embodiment, an input for providing the gesture mode may include obtaining or identifying a designated gesture input using the movement information of the hand obtained via the sensor 440.

According to an embodiment, the wrist-wearable electronic device 401 may change from the state 1202 to a state 1203, in response to receiving an input for providing the gesture mode in the state 1202.

In the state 1203, the wrist-wearable electronic device 401 may provide the gesture mode. While providing the gesture mode, the wrist-wearable electronic device 401 may cease or refrain from displaying the visual object 830 and/or the visual object 840. While providing the gesture mode, the wrist-wearable electronic device 401 may execute a function corresponding to a designated gesture input (e.g., a gesture input of fist-clenching, a gesture input of contacting the thumb and index finger) in response to identifying the designated gesture input. The wrist-wearable electronic device 401 may display a visual effect for the visual object 1210 via the display 420. For example, the visual effect may include an effect of changing a color of a periphery of the visual object 1210. For example, the visual effect may be referred to as a highlight effect. For example, the visual effect may indicate that the visual object 1210 corresponding to the visual effect has been selected. For example, the wrist-wearable electronic device 401 may execute a function for the visual object 1210, in response to identifying the gesture input of fist-clenching.

While providing the gesture mode, the wrist-wearable electronic device 401 may receive user input information from the finger-wearable electronic device 402 via communication circuitry (e.g., the communication circuitry 430). The wrist-wearable electronic device 401 may change from the state 1203 to a state 1204, based on the user input information.

In the state 1204, the wrist-wearable electronic device 401 may change a visual object processed with the visual effect from the visual object 1210 to the visual object 1220 in accordance with the user input information. The wrist-wearable electronic device 401 may cease or refrain from displaying a visual effect for the visual object 1210 in accordance with the user input information. The wrist-wearable electronic device 401 may display, via the display 420, a visual effect for the visual object 1220 in accordance with the user input information. In the state 1204, the wrist-wearable electronic device 401 may select the visual object 1220 corresponding to the visual effect. For example, the wrist-wearable electronic device 401 may execute a function for the visual object 1220, in response to identifying the gesture input of fist-clenching.

According to an embodiment, the wrist-wearable electronic device 401 may receive an input for releasing the gesture mode, while providing the gesture mode. The wrist-wearable electronic device 401 may identify a gesture input for releasing the gesture mode while providing the gesture mode. The wrist-wearable electronic device 401 may perform operations (e.g., operation 701, operation 703, operation 705, and operation 707) of FIG. 7, in response to releasing the gesture mode.

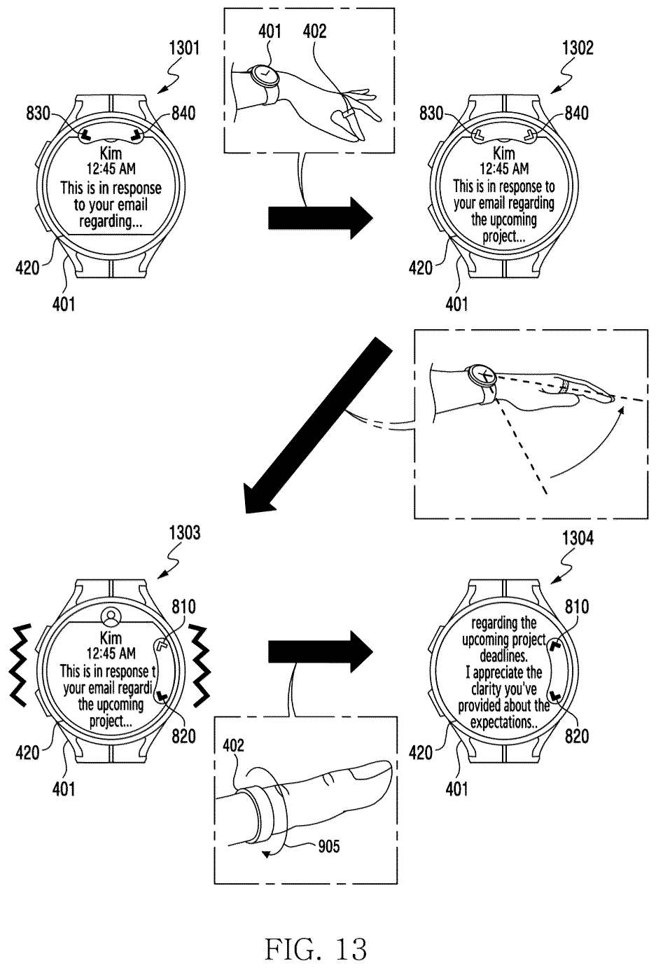

FIG. 13 illustrates an example of a wrist-wearable electronic device 401 that executes a function corresponding to a gesture input according to an embodiment.

Referring to FIG. 13, in a state 1301, the wrist-wearable electronic device 401 may determine that an angle (e.g., the angle 610) between the wrist-wearable electronic device 401 and the finger-wearable electronic device 402 is included in a second angle range (e.g., the second angle range 612). The wrist-wearable electronic device 401 may display, via a display 420, a visual object 830 and/or a visual object 840. The wrist-wearable electronic device 401 may obtain movement information of a hand wearing the wrist-wearable electronic device 401 via a sensor (e.g., the sensor 440). The wrist-wearable electronic device 401 may identify or obtain a gesture input using the movement information of the hand. The gesture input may be set in the wrist-wearable electronic device 401. For example, the gesture input may include a gesture in which the thumb of the hand and the index finger of the hand contact each other more than once. For example, the gesture input may include a pinch gesture and/or a double pinch gesture. The wrist-wearable electronic device 401 may change the state 1301 to a state 1302, in response to obtaining or identifying the gesture input of the hand. The wrist-wearable electronic device 401 may change the state 1301 to the state 1302 by executing a function corresponding to the gesture input of the hand. For example, the wrist-wearable electronic device 401 may execute a function related to a message notification within a screen displayed via the display 420, based on obtaining the gesture input of the hand. For example, the function related to message notification may include execution of a message application.

The state 1302 may be a state in which the function corresponding to the gesture input of the hand is executed in the wrist-wearable electronic device 401. For example, the wrist-wearable electronic device 401 may execute a message application. The wrist-wearable electronic device 401 may identify that it is impossible to move or scroll a screen along an axis perpendicular to a strap of the wrist-wearable electronic device 401. The wrist-wearable electronic device 401 may display, via the display 420, a visual effect for the visual object 830 and/or a visual effect for the visual object 840. The wrist-wearable electronic device 401 may move or scroll a screen along an axis parallel to a strap of the wrist-wearable electronic device 401. The wrist-wearable electronic device 401 may identify or determine that an angle (e.g., the angle 610) between the wrist-wearable electronic device 401 and the finger-wearable electronic device 402 is included in a first angle range (e.g., the first angle range 611). The wrist-wearable electronic device 401 may change from the state 1302 to a state 1303 in accordance with a determination that the angle 610 is included in the first angle range 611.

In the state 1303, the wrist-wearable electronic device 401 may cease, refrain from, or bypass displaying the visual object 830 and/or the visual object 840, in accordance with a determination that the angle 610 is included in the first angle range 611. The wrist-wearable electronic device 401 may display, via the display 420, the visual object 810 and/or the visual object 820, in accordance with a determination that the angle 610 is included in the first angle range 611. The wrist-wearable electronic device 401 may receive user input information from the finger-wearable electronic device 402 via communication circuitry (e.g., the communication circuitry 430). The wrist-wearable electronic device 401 may change from the state 1303 to a state 1304, based on the received user input information.

According to an embodiment, the wrist-wearable electronic device 401 may output haptic feedback via a haptic module (e.g., the haptic module 179) by changing the state 1302 to the state 1303. For example, the wrist-wearable electronic device 401 may output haptic feedback via a haptic module (e.g., the haptic module 179), in response to identifying that the angle 610 is changed from within the second angle range 612 to within the first angle range 611. As a non-limiting example, the wrist-wearable electronic device 401 may output haptic feedback via a haptic module (e.g., the haptic module 179), in response to identifying that the angle 610 is changed from within the first angle range 611 to within the second angle range 612.

In the state 1304, the wrist-wearable electronic device 401 may display, via the display 420, another screen different from a screen displayed in the state 1303, based on the user input information. For example, the user input information may include gyro information indicating that the finger-wearable electronic device 402 rotates in a first direction 905. For example, the user input information may include scroll information indicating that a surface on which a touch sensor of the finger-wearable electronic device 402 is disposed is scrolled in the first direction 905 by a user's body (e.g., a finger). The wrist-wearable electronic device 401 may display, via the display 420, a scroll animation in which a screen is scrolled in a direction corresponding to the visual object 820, in accordance with the user input information. The wrist-wearable electronic device 401 may display, via the display 420, another screen different from a screen displayed in the state 1303 by the screen displayed in the state 1303 being scrolled, according to user input information. For example, the wrist-wearable electronic device 401 may display, through the display 420, text after text within a screen displayed in the state 1303, by the screen displayed in the state 1303 being scrolled, in accordance with the user input information.

FIG. 14A illustrates a wearable device 1400 (e.g., the finger-wearable electronic device 402) according to an embodiment.

Referring to FIG. 14A, the wearable device 1400 may include a housing 1410.

According to an embodiment, the wearable device 1400 may be worn by a user. For example, the wearable device 1400 may include the wearable device 401, the wearable device 701, and the wearable device 1101. A user may indicate a person wearing the wearable device 1400. The wearable device 1400 may be worn on a body part 1470 of the user. For example, the wearable device 1400 may be worn on the body part 1470 of the use. For example, the wearable device 1400 may be fastened to the body part 1470 of the user. For example, the wearable device 1400 may be detachable with respect to the body part 1470 of the user.

For example, the wearable device 1400 may be in contact with the body part 1470 of the user by being worn on the user. For example, the wearable device 1400 may be configured to obtain information related to the user via the body part 1470 of the user, by being worn on the user. For example, the wearable device 1400 may provide the user with information indicating a state of the user, based on obtaining information related to the user. For example, the wearable device 1400 may be configured to display information indicating the state of the user via a display module of the wearable device 1400 and/or an electronic device (e.g., the electronic device 301 of FIG. 3) connected to the wearable device 1400, thereby providing the user with the information indicating the state of the user. In terms of providing information related to the user wearing the wearable device 1400 to the user via the electronic device 301 connected to the wearable device 1400, the wearable device 1400 may be referred to as the wearable device 401 of FIG. 4. However, embodiments are not limited thereto.

The user's body part 1470 on which the wearable device 1400 is worn may be the user's finger. For example, a housing 1410 of the wearable device 1400 may have a ring shape so that the wearable device 1400 is worn on the user's finger. However, embodiments are not limited thereto. The wearable device 1400 may have a shape corresponding to the body part 1470 to be worn on the body part 1470 of the user.

According to an embodiment, the housing 1410 may include a first surface 1410a facing a first body part 1470 of the user while the wearable device 1400 is worn on the first body part 1470 of the user, and a second surface 1410b opposite the first surface 1410a. The first body part 1470 may be one of the user's fingers. For example, when the wearable device 1400 is worn on the user, the first surface 1410a may be at least partially contacted to the first body part 1470 of the user. For example, the first surface 1410a may surround the user's first body part 1470 on which the wearable device 1400 is worn. For example, the first surface 1410a may cover the user's first body part 1470 on which the wearable device 1400 is worn. For example, the first surface 1410a may be configured to pressurize the user's first body part 1470 when the wearable device 1400 is worn on the user, so that the wearable device 1400 may be fastened to the first body part 1470.

For example, the second surface 1410b may form an exterior of the electronic device 301 together with the first surface 1410a. For example, the second surface 1410b may form a ring-shaped housing 1410 together with the first surface 1410a. For example, the second surface 1410b may be a surface spaced apart from the user's first body part 1470 when the electronic device 301 is worn on the user's first body part 1470. For example, the first surface 1410a may be the closest surface to the user's first body part 1470 while the electronic device 301 is worn on the user's first body part 1470. The second surface 1410b opposite to the first surface 1410a may be the farthest surface from the first body part 1470. For example, the first surface 1410a may be referred to as an inner circumference surface of the housing 1410. The second surface 1410b opposite the first surface 1410a may be referred to as an outer circumference surface of the housing 1410.

Although it has been described that the wearable device 1400 is worn on the first body part 1470 of the user, embodiments are not limited thereto. It should be noted that the first body part 1470 is merely for explaining the user's body part 1470 on which the wearable device 1400 is worn, and it does not limit the user's body part 1470 on which the wearable device 1400 is worn or limit an arrangement relationship between the body part 1470 and the wearable device 1400. For example, the first body portion 1470 may be one of the user's fingers, but embodiments are not limited thereto.

According to an embodiment, the housing 1410 may include a first frame 1411 defining the first surface 1410a, and a second frame 1412 defining the second surface 1410b and coupling with the first frame 1411. For example, the first frame 1411 may be a portion of the housing 1410 including the first surface 1410a. For example, when the wearable device 1400 is worn by the user, the first frame 1411 may be in contact with the body part 1470 of the user. For example, the first surface 1410a may form at least a portion of an exterior of the first frame 1411. The second surface 1410b opposite to the first surface 1410a may form at least a portion of an exterior of the second frame 1412. For example, in terms of being in contact with the body part 1470 of the user while the wearable device 1400 is worn by the user, the first frame 1411 may be referred to as an inner wall of the housing 1410. For example, in terms of at least partially surrounding the body part 1470 of the user while the wearable device 1400 is worn by the user, the first surface 1410a of the first frame 1411 may be referred to as an inner surface of the housing 1410. For example, in terms of being coupled to the first frame 1411 so as to surround the first frame 1411, the second frame 1412 may be referred to as an outer wall of the housing 1410. The second surface 1410b of the second frame 1412 may be referred to as an outer surface of the housing 1410 in that it is a periphery that does not contact with the body part 1470 on which the wearable device 1400 is worn while the wearable device 1400 is worn by the user. For example, when referring to FIG. 14B together, the first frame 1411 may provide a medium for a path of light emitted from a light emitting unit 1451. The first frame 1411 may include at least one of silicon, epoxy, and acryl, but embodiments are not limited thereto.

For example, the second frame 1412 may surround the first frame 1411. For example, the second frame 1412 may support the first frame 1411. For example, the second frame 1412 may form an exterior of the housing 1410 together with the first frame 1411. For example, the second frame 1412 may be a portion of the housing 1410, including the second surface 1410b opposite to the first surface 1410a. The second frame 1412 may include at least one of metal and titanium, but embodiments are not limited thereto. The housing 1410 of the wearable device 1400 may include the first frame 1411 and the second frame 1412 that include different materials, thereby providing various user experiences to the user.

FIG. 14B is a cross-sectional view of a wearable device 1400 (e.g., the finger-wearable electronic device 402) according to an embodiment.

Referring to FIG. 14B, the wearable device 1400 may include electronic components in the housing 1410 to perform a function of the wearable device 1400. For example, the wearable device 1400 may include a processor 1401, a communication module 1402, memory 1403, an antenna module 1404, and a power management module 1405. The power management module 1405 may be implemented as at least a portion of a power management integrated circuit (PMIC).

According to an embodiment, the wearable device 1400 may include a battery 1430 for charging the wearable device 1400 and a printed circuit board 1440 (PCB) in the housing 1410 connected to the battery 1430. For example, the processor 1401, the communication module 1402, the memory 1403, and the power management module 1405 may be mounted on the printed circuit board 1440. The power management module 1405 may be configured to manage power supplied to the wearable device 1400. For example, the battery 1430 may include a charging interface 1435 connected to the printed circuit board 1440 and configured to receive power from an external power source for charging the battery 1430. The battery 1430 may be charged through the power supplied through the charging interface 1435. The battery 1430 may be connected to the printed circuit board 1440 to supply power to at least a portion of the electronic components on the printed circuit board 1440.

According to an embodiment, the printed circuit board 1440 may include at least one of a flexible printed circuit board (FPCB) and a rigid flexible printed circuit board (RFPCB) depending on the material thereof, but embodiments are not limited thereto.

The processor 1401 may be configured to control at least a portion of the electronic components in the wearable device 1400. The processor 1401 may control the electronic components in the wearable device 1400 through communication with an external electronic device (e.g., the electronic device 301 of FIG. 3) connected to the wearable device 1400.

The communication module 1402 may connect an external electronic device and the wearable device 1400. Through the communication module 1402, the processor 1401 may control at least a portion of the electronic components in the wearable device 1400 based on a user input inputted to the external electronic device, or cause an event for executing a function of the external electronic device. For example, the processor 1401 of the wearable device 1400 may be configured to execute an application of the external electronic device through the communication module 1402 and a processor (e.g., at least one processor 300 of FIG. 3) in the external electronic device. However, embodiments are not limited thereto.

According to an embodiment, the communication module 1402 may connect the wearable device 1400 to an external electronic device through near field communication. For example, the communication module 1402 may connect the wearable device 1400 and the external electronic device, based on an external electronic device within a specified distance range from the wearable device 1400. However, embodiments are not limited thereto. The communication module 1402 may establish a wireless communication network for communication with an external electronic device through Wi-Fi, NFC, Zigbee, Bluetooth, Radio Frequency Identification (RFID), or a combination thereof. The communication module 1402 may transmit a user input to the wearable device 1400 to the external electronic device or receive a user input to the external electronic device from the external electronic device, through a short-range wireless communication network between the wearable device 1400 and the external electronic device.

The electronic components included in the wearable device 1400 are not limited to the above-described configuration. For example, the wearable device 1400 may include various sensors including a temperature sensor, a proximity sensor, a motion sensor, and a pressure sensor.

According to an embodiment, the wearable device 1400 may include a first sensor module 1450, including a light-emitting unit 1451 facing the first surface 1410a of the housing 1410 and a light-receiving unit 1452 spaced apart from the light-emitting unit 1451, configured to sense biometric information on a user.

According to an embodiment, the processor 1401 may be configured to emit light using the light emitting unit 1451 of the first sensor module 1450. The processor 1401 may be configured to obtain information related to an external environment through at least a portion of light received by the light receiving unit 1452 after being emitted from the light emitting unit 1451, by using the light receiving unit 1452 of the first sensor module 1450.

For example, the first sensor module 1450 may be disposed in an inner space of the housing 1410 between the first surface 1410a and the second surface 1410b. For example, the first sensor module 1450 may be disposed on a component (e.g., the printed circuit board 1440) of the wearable device 1400 between the first surface 1410a and the second surface 1410b. The first sensor module 1450 may be electrically connected to the component. For example, the first sensor module 1450 may be configured to sense the user's state by using a user's body part 1470 wearing the wearable device 1400. The wearable device 1400 may be configured to provide the user with information related to the state through the sensed state of the user. For example, the first sensor module 1450 may include at least one of an optical sensor or a heart rate measurement (HRM) sensor using photoplethysmography (PPG), but embodiments are not limited thereto. The light emitting unit 1451 may be referred to as a light emitting diode (LED), and the light receiving unit 1452 may be referred to as a photo diode, but embodiments are not limited thereto.

For example, the light emitting unit 1451 may be configured to emit light in a plurality of directions. A portion of light emitted from the light emitting unit 1451 in the plurality of directions may be reflected by the user's body part 1470 wearing the electronic device 301. For example, the light-emitting unit 1451 may be configured to emit light toward the user's body part 1470 on which the wearable device 1400 is worn. The light emitted from the light-emitting unit 1451 toward the user's body part 1470 may be reflected by the body part 1470.

For example, the light receiving unit 1452 may be configured to receive a portion of light emitted from the light emitting unit 1451 in a plurality of directions. For example, the light emitting unit 1451 may be configured to emit light toward the user's body part 1470 on which the electronic device 301 is worn. The light receiving unit 1452 may be configured to receive a portion of light reflected by the user's body part 1470. The light receiving unit 1452 may be configured to receive the portion of the light through a space and/or a medium between the first surface 1410a and the second surface 1410b of the housing 1410.

For example, the first sensor module 1450 may be configured to sense a state of the user, based on light emitted from the light emitting unit 1451 and reflected by the user's body part 1470 being received by the light receiving unit 1452. The electronic device 301 may be configured to obtain information related to the user's state from the sensor module 1450. For example, the light-emitting unit 1451 may emit light toward the user's first body portion 1470 on which the wearable device 1400 is worn. The light receiving unit 1452 may receive at least a portion of light emitted from the light emitting unit 1451 and reflected by the first body portion 1470. The first sensor module 1450 may be configured to sense the user's state through at least a portion of the light reflected by the first body part 1470.

According to an embodiment, the light emitting unit 1451 may include a plurality of light emitting units 1451a, 1451b, and 1451c. Each of the plurality of light emitting units 1451a, 1451b, and 1451c may face the first surface 1410a of the housing 1410 to emit light toward the user's body part 1470 on which the wearable device 1400 is worn. According to an embodiment, the light receiving unit 1452 may include a plurality of light receiving units 1452a, 1452b, and 1452c. Each of the plurality of light receiving units 1452a, 1452b, and 1452c may face the first surface 1410a of the housing 1410 to receive at least a portion of light emitted from the light emitting unit 1451 and reflected by the user's body part 1470 wearing the wearable device 1400.

According to an embodiment, in order to provide a user with a variety of user experiences, based on the wearable device 1400 being worn on the user's body part 1470, the wearable device 1400 may be required to cause an event for executing a function of an external electronic device connected to the wearable device 1400 through a motion of the user's body part 1470 and/or the user's biometric information (e.g., fingerprint).

The wearable device 1400 according to the above-described embodiment may provide various user experiences to the user by being wearable on the user's body part 1470. The wearable device 1400 may be configured to increase the user's wearability and provide the user with information related to the user, by including the housing 1410 including the first surface 1410a configured to face the user's body part 1470.

In an embodiment according to the present disclosure, a wrist-wearable electronic device (e.g., the wrist-wearable electronic device 401) and a finger-wearable electronic device (e.g., the finger-wearable electronic device 402) may be worn on one hand of a user. The wrist-wearable electronic device 401 may receive user input information for the finger-wearable electronic device 402 via communication circuitry (e.g., the communication circuitry 430). The wrist-wearable electronic device 401 may recognize the received user input information as an input. The wrist-wearable electronic device 401 may change a screen displayed via a display (e.g., the display 420) according to the received user input information. The user of the wrist-wearable electronic device 401 may control or navigate the wrist-wearable electronic device 401 with one hand operation. The wrist-wearable electronic device 401 may enhance usability by being controlled through a one-hand operation by the user.

The effects that can be obtained from the present disclosure are not limited to those described above, and any other effects not mentioned herein will be clearly understood by those having ordinary knowledge in the art to which the present disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, an electronic device, or a home appliance. According to an embodiment of the disclosure, the electronic devices are not limited to those described above.

It should be appreciated that various embodiments and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it indicates that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136, external memory 138, memory 410, and memory 460) that is readable by a machine (e.g., the electronic device 101 of FIG. 1, the wrist-wearable electronic device 401 of FIG. 4, and the finger-wearable electronic device 402 of the FIG. 4). For example, a processor (e.g., the processor 120, the at least one processor 400, and the at least one processor 450) of the machine (e.g., the electronic device 101, the wrist-wearable electronic device 401, and the finger-wearable electronic device 402) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply indicates that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in this document are not limited to those described above, and other technical problems not mentioned herein will be clearly understood by those having ordinary knowledge in the art to which the present disclosure belongs, from the following description.

As described above, a wrist-wearable electronic device may include a sensor. The wrist-wearable electronic device may include communication circuitry. The wrist-wearable electronic device may include a display. The wrist-wearable electronic device may include memory, including one or more storage media, storing instructions. The wrist-wearable electronic device may include at least one processor including processing circuitry. The instructions, when executed by the at least one processor individually or collectively, may cause the wrist-wearable electronic device to, while a first screen is displayed via the display, based on sensor data obtained via the sensor, obtain information related to an angle between the wrist-wearable electronic device and a finger-wearable electronic device connected to the wrist-wearable electronic device. The instructions, when executed by the at least one processor individually or collectively, may cause the wrist-wearable electronic device to, based on the information related to the angle, determine, in a first determination, whether the angle is included in a first angle range or a second angle range distinguished from the first angle range. The instructions, when executed by the at least one processor individually or collectively, may cause the wrist-wearable electronic device to, receive, via the communication circuitry, a user input information for the finger-wearable electronic device from the finger-wearable electronic device. The instructions, when executed by the at least one processor individually or collectively, may cause the wrist-wearable electronic device to, based on the user input information being received from the finger-wearable electronic device and the first determination indicating that the angle is included in the first angle range, display, via the display, a second screen changed from the first screen. The instructions, when executed by the at least one processor individually or collectively, may cause the wrist-wearable electronic device to, based on the user input information being received from the finger-wearable electronic device and the first determination indicating that the angle is included in the second angle range, display, via the display, a third screen, changed from the first screen, distinguished from the second screen.

According to an embodiment, the instructions, when executed by the at least one processor individually or collectively, may cause the wrist-wearable electronic device to, in accordance with the first determination indicating that the angle is included in the first angle range, while changing the first screen to the second screen, display, via the display, a first scroll animation in which the first screen moves along a first axis parallel to a strap of the wrist-wearable electronic device. The instructions, when executed by the at least one processor individually or collectively, may cause the wrist-wearable electronic device to, in accordance with the first determination indicating that the angle is included in the second angle range, while changing the first screen to the third screen, display, via the display, a second scroll animation in which the first screen moves along a second axis perpendicular to the first axis.

According to an embodiment, the instructions, when executed by the at least one processor individually or collectively, cause the wrist-wearable electronic device to, increase a velocity of the first scroll animation and a velocity of the second scroll animation as the angle increases.

According to an embodiment, the first screen may comprise a list of visual objects. The instructions, when executed by the at least one processor individually or collectively, may cause the wrist-wearable electronic device to, in accordance with the first determination indicating that the angle is included in the first angle range, determine, in a second determination, whether the user input information includes scroll information of the finger-wearable electronic device or gyro information of the finger-wearable electronic device. The instructions, when executed by the at least one processor individually or collectively, may cause the wrist-wearable electronic device to, in accordance with the second determination indicating that the user input information includes the scroll information, display, via the display, a first scroll animation in which each of the visual objects is scrolled. The instructions, when executed by the at least one processor individually or collectively, may cause the wrist-wearable electronic device to, in accordance with the second determination indicating that the user input information includes the gyro information, display, via the display, a second scroll animation in which each of groups of the visual objects is scrolled.

According to an embodiment, the instructions, when executed by the at least one processor individually or collectively, may cause the wrist-wearable electronic device to, in accordance with the first determination indicating that the angle is included in the first angle range, display, via the display, a first visual object for guiding scrolling of the first screen in a first direction of an axis parallel to a strap of the wrist-wearable electronic device and a second visual object for guiding scrolling of the first screen in a second direction opposite to the first direction. The instructions, when executed by the at least one processor individually or collectively, may cause the wrist-wearable electronic device to, in accordance with the first determination indicating that the angle is included in the second angle range, display, via the display, a third visual object for guiding scrolling of the first screen in a third direction perpendicular to the first direction and a fourth visual object for guiding scrolling of the first screen in a fourth direction opposite to the third direction.

According to an embodiment, the instructions, when executed by the at least one processor individually or collectively, may cause the wrist-wearable electronic device to, based on identifying that the scrolling of the first screen in the first direction has failed a predetermined number of times, display, via the display, a visual effect for the first visual object.

According to an embodiment, the instructions, when executed by the at least one processor individually or collectively, may cause the wrist-wearable electronic device to, after changing the first screen to the second screen or the third screen, obtain, via the sensor, a gesture input of a hand connected to a wrist wearing the wrist-wearable electronic device. The instructions, when executed by the at least one processor individually or collectively, may cause the wrist-wearable electronic device to execute a function corresponding to the gesture input.

According to an embodiment, the instructions, when executed by the at least one processor individually or collectively, may cause the wrist-wearable electronic device to, after changing the first screen to the second screen or the third screen, receive, via the communication circuitry, additional user input information from the finger-wearable electronic device. The instructions, when executed by the at least one processor individually or collectively, may cause the wrist-wearable electronic device to, based on identifying that the additional user input information is less than reference user input information, provide a gesture mode for recognizing a movement of a hand connected to a wrist wearing the wrist-wearable electronic device as an input. The instructions, when executed by the at least one processor individually or collectively, may cause the wrist-wearable electronic device to, while providing the gesture mode, based on identifying a gesture input of the hand obtained via the sensor, execute a function corresponding to the gesture input.

According to an embodiment, the instructions, when executed by the at least one processor individually or collectively, may cause the wrist-wearable electronic device to provide a gesture mode for recognizing a movement of a hand connected to a wrist wearing the wrist-wearable electronic device as an input. The instructions, when executed by the at least one processor individually or collectively, may cause the wrist-wearable electronic device to, while providing the gesture mode, receive, via the communication circuitry, additional user input information from the finger-wearable electronic device. The instructions, when executed by the at least one processor individually or collectively, may cause the wrist-wearable electronic device to, while providing the gesture mode, select a visual object within a screen displayed via the display in accordance with the additional user input information. The instructions, when executed by the at least one processor individually or collectively, may cause the wrist-wearable electronic device to, while providing the gesture mode, based on identifying a gesture input of the hand obtained via the sensor, execute a function corresponding to the selected visual object.

According to an embodiment, the instructions, when executed by the at least one processor individually or collectively, may cause the wrist-wearable electronic device to, while providing the gesture mode, based on identifying an input for releasing the gesture mode, obtain additional information related to another angle between the wrist-wearable electronic device and the finger-wearable electronic device. The instructions, when executed by the at least one processor individually or collectively, may cause the wrist-wearable electronic device to, based on the additional information related to the other angle, determine, in a second determination, whether the other angle is included in the first angle range or the second angle range. The instructions, when executed by the at least one processor individually or collectively, may cause the wrist-wearable electronic device to, in accordance with the second determination indicating that the other angle is included in the first angle range, receive, via the communication circuitry, second additional user input information for the finger-wearable electronic device from the finger-wearable electronic device. The instructions, when executed by the at least one processor individually or collectively, may cause the wrist-wearable electronic device to, in accordance with the second determination indicating that the other angle is included in the first angle range, based on the second additional user input information, display, via the display, a fifth screen. The instructions, when executed by the at least one processor individually or collectively, may cause the wrist-wearable electronic device to, in accordance with the second determination indicating that the other angle is included in the second angle range, receive, via the communication circuitry, the second additional user input information from the finger-wearable electronic device. The instructions, when executed by the at least one processor individually or collectively, may cause the wrist-wearable electronic device to, in accordance with the second determination indicating that the other angle is included in the second angle range, based on the second additional user input information, display, via the display, a sixth screen distinguished from the fifth screen.

According to an embodiment, the instructions, when executed by the at least one processor individually or collectively, may cause the wrist-wearable electronic device to, in accordance with the first determination indicating that the angle is included in the first angle range, based on identifying that changing the first screen to the second screen is impossible, determine a failure of an input. According to an embodiment, the instructions, when executed by the at least one processor individually or collectively, may cause the wrist-wearable electronic device to, in accordance with the first determination indicating that the angle is included in the first angle range, based on identifying that the number of failures of the input is greater than a reference number, execute a function to correct an operation for determining the angle.

According to an embodiment, the instructions, when executed by the at least one processor individually or collectively, may cause the wrist-wearable electronic device to, in accordance with the first determination indicating that the angle is included in the first angle range, based on identifying that another angle between the wrist-wearable electronic device and the finger-wearable electronic device is included in the second angle range, determine a change of a mode. The instructions, when executed by the at least one processor individually or collectively, may cause the wrist-wearable electronic device to, based on identifying the number of changes of the mode being greater than a reference number during a reference time, execute a function to correct an operation for determining the angle.

According to an embodiment, the instructions, when executed by the at least one processor individually or collectively, may cause the wrist-wearable electronic device to, while the first screen is displayed via the display, obtain, via the sensor, the sensor data. The instructions, when executed by the at least one processor individually or collectively, may cause the wrist-wearable electronic device to, while the first screen is displayed via the display, receive, via the communication circuitry, additional sensor data of the finger-wearable electronic device from the finger-wearable electronic device. The instructions, when executed by the at least one processor individually or collectively, may cause the wrist-wearable electronic device to, while the first screen is displayed via the display, based on the sensor data and the additional sensor data, obtain the information related to the angle between the wrist-wearable electronic device and the finger-wearable electronic device.

As described above, a method performed by a wrist-wearable electronic device with a display, communication circuitry, and a sensor may include, while a first screen is displayed via the display, based on sensor data obtained via the sensor, obtain information related to an angle between the wrist-wearable electronic device and a finger-wearable electronic device connected to the wrist-wearable electronic device. The method may include, based on the information related to the angle, determine, in a first determination, whether the angle is included in a first angle range or a second angle range distinguished from the first angle range. The method may include, receive, via the communication circuitry, a user input information for the finger-wearable electronic device from the finger-wearable electronic device. The method may include, based on the user input information being received from the finger-wearable electronic device and the first determination indicating that the angle is included in the first angle range, display, via the display, a second screen changed from the first screen. The method may include, based on the user input information being received from the finger-wearable electronic device and the first determination indicating that the angle is included in the second angle range, display, via the display, a third screen, changed from the first screen, distinguished from the second screen.

According to an embodiment, the method may include, in accordance with the first determination indicating that the angle is included in the first angle range, while changing the first screen to the second screen, display, via the display, a first scroll animation in which the first screen moves along a first axis parallel to a strap of the wrist-wearable electronic device. The method may include, in accordance with the first determination indicating that the angle is included in the second angle range, while changing the first screen to the third screen, display, via the display, a second scroll animation in which the first screen moves along a second axis perpendicular to the first axis.

According to an embodiment, the instructions, when executed by the at least one processor individually or collectively, cause the wrist-wearable electronic device to, increase a velocity of the first scroll animation and a velocity of the second scroll animation as the angle increases.

According to an embodiment, the first screen may comprise a list of visual objects. The method may include, in accordance with the first determination indicating that the angle is included in the first angle range, determine, in a second determination, whether the user input information includes scroll information of the finger-wearable electronic device or gyro information of the finger-wearable electronic device. The method may include, in accordance with the second determination indicating that the user input information includes the scroll information, display, via the display, a first scroll animation in which each of the visual objects is scrolled. The method may include, in accordance with the second determination indicating that the user input information includes the gyro information, display, via the display, a second scroll animation in which each of groups of the visual objects is scrolled.

According to an embodiment, the method may include, in accordance with the first determination indicating that the angle is included in the first angle range, display, via the display, a first visual object for guiding scrolling of the first screen in a first direction of an axis parallel to a strap of the wrist-wearable electronic device and a second visual object for guiding scrolling of the first screen in a second direction opposite to the first direction. The method may include, in accordance with the first determination indicating that the angle is included in the second angle range, display, via the display, a third visual object for guiding scrolling of the first screen in a third direction perpendicular to the first direction and a fourth visual object for guiding scrolling of the first screen in a fourth direction opposite to the third direction.

According to an embodiment, the method may include, based on identifying that the scrolling of the first screen in the first direction has failed a predetermined number of times, display, via the display, a visual effect for the first visual object.

According to an embodiment, the method may include, after changing the first screen to the second screen or the third screen, obtain, via the sensor, a gesture input of a hand connected to a wrist wearing the wrist-wearable electronic device. The instructions, when executed by the at least one processor individually or collectively, may cause the wrist-wearable electronic device to execute a function corresponding to the gesture input.

According to an embodiment, the method may include, after changing the first screen to the second screen or the third screen, receive, via the communication circuitry, additional user input information from the finger-wearable electronic device. The method may include, based on identifying that the additional user input information is less than reference user input information, provide a gesture mode for recognizing a movement of a hand connected to a wrist wearing the wrist-wearable electronic device as an input. The method may include, while providing the gesture mode, based on identifying a gesture input of the hand obtained via the sensor, execute a function corresponding to the gesture input.

According to an embodiment, the instructions, when executed by the at least one processor individually or collectively, may cause the wrist-wearable electronic device to provide a gesture mode for recognizing a movement of a hand connected to a wrist wearing the wrist-wearable electronic device as an input. The method may include, while providing the gesture mode, receive, via the communication circuitry, additional user input information from the finger-wearable electronic device. The method may include, while providing the gesture mode, select a visual object within a screen displayed via the display in accordance with the additional user input information. The method may include, while providing the gesture mode, based on identifying a gesture input of the hand obtained via the sensor, execute a function corresponding to the selected visual object.

According to an embodiment, the method may include, while providing the gesture mode, based on identifying an input for releasing the gesture mode, obtain additional information related to another angle between the wrist-wearable electronic device and the finger-wearable electronic device. The method may include, based on the additional information related to the other angle, determine, in a second determination, whether the other angle is included in the first angle range or the second angle range. The method may include, in accordance with the second determination indicating that the other angle is included in the first angle range, receive, via the communication circuitry, second additional user input information for the finger-wearable electronic device from the finger-wearable electronic device. The method may include, in accordance with the second determination indicating that the other angle is included in the first angle range, based on the second additional user input information, display, via the display, a fifth screen. The method may include, in accordance with the second determination indicating that the other angle is included in the second angle range, receive, via the communication circuitry, the second additional user input information from the finger-wearable electronic device. The method may include, in accordance with the second determination indicating that the other angle is included in the second angle range, based on the second additional user input information, display, via the display, a sixth screen distinguished from the fifth screen.

According to an embodiment, the method may include, in accordance with the first determination indicating that the angle is included in the first angle range, based on identifying that changing the first screen to the second screen is impossible, determine a failure of an input. According to an embodiment, the method may include, in accordance with the first determination indicating that the angle is included in the first angle range, based on identifying that the number of failures of the input is greater than a reference number, execute a function to correct an operation for determining the angle.

According to an embodiment, the method may include, in accordance with the first determination indicating that the angle is included in the first angle range, based on identifying that another angle between the wrist-wearable electronic device and the finger-wearable electronic device is included in the second angle range, determine a change of a mode. The method may include, based on identifying the number of changes of the mode being greater than a reference number during a reference time, execute a function to correct an operation for determining the angle.

According to an embodiment, the method may include, while the first screen is displayed via the display, obtain, via the sensor, the sensor data. The method may include, while the first screen is displayed via the display, receive, via the communication circuitry, additional sensor data of the finger-wearable electronic device from the finger-wearable electronic device. The method may include, while the first screen is displayed via the display, based on the sensor data and the additional sensor data, obtain the information related to the angle between the wrist-wearable electronic device and the finger-wearable electronic device.

As described above, a non-transitory computer readable storage medium storing one or more programs, the one or more programs may include instructions to, when executed by a wrist-wearable electronic device with a display, communication circuitry, and a sensor, cause the wrist-wearable electronic device to, while a first screen is displayed via the display, based on sensor data obtained via the sensor, obtain information related to an angle between the wrist-wearable electronic device and a finger-wearable electronic device connected to the wrist-wearable electronic device. The one or more programs may include instructions to, when executed by the wrist-wearable electronic device, cause the wrist-wearable electronic device to, based on the information related to the angle, determine, in a first determination, whether the angle is included in a first angle range or a second angle range distinguished from the first angle range. The one or more programs may include instructions to, when executed by the wrist-wearable electronic device, cause the wrist-wearable electronic device to, receive, via the communication circuitry, a user input information for the finger-wearable electronic device from the finger-wearable electronic device. The one or more programs may include instructions to, when executed by the wrist-wearable electronic device, cause the wrist-wearable electronic device to, based on the user input information being received from the finger-wearable electronic device and the first determination indicating that the angle is included in the first angle range, display, via the display, a second screen changed from the first screen. The one or more programs may include instructions to, when executed by the wrist-wearable electronic device, cause the wrist-wearable electronic device to, based on the user input information being received from the finger-wearable electronic device and the first determination indicating that the angle is included in the second angle range, display, via the display, a third screen, changed from the first screen, distinguished from the second screen.

According to an embodiment, the one or more programs may comprise instructions to, when executed by the wrist-wearable electronic device, cause the wrist-wearable electronic device to, in accordance with a determination that the angle is included in the first angle range, while changing the first screen to the second screen, display, via the display, a first scroll animation in which the first screen moves along a first axis parallel to a strap of the wrist-wearable electronic device. The one or more programs may comprise instructions to, when executed by the wrist-wearable electronic device, cause the wrist-wearable electronic device to, in accordance with a determination that the angle is included in the second angle range, while changing the first screen to the third screen, display, via the display, a second scroll animation in which the first screen moves along a second axis perpendicular to the first axis.

According to an embodiment, the one or more programs may include instructions to, when executed by the wrist-wearable electronic device, cause the wrist-wearable electronic device to, in accordance with the first determination indicating that the angle is included in the first angle range, while changing the first screen to the second screen, display, via the display, a first scroll animation in which the first screen moves along a first axis parallel to a strap of the wrist-wearable electronic device. The one or more programs may include instructions to, when executed by the wrist-wearable electronic device, cause the wrist-wearable electronic device to, in accordance with the first determination indicating that the angle is included in the second angle range, while changing the first screen to the third screen, display, via the display, a second scroll animation in which the first screen moves along a second axis perpendicular to the first axis.

According to an embodiment, the instructions, when executed by the at least one processor individually or collectively, cause the wrist-wearable electronic device to, increase a velocity of the first scroll animation and a velocity of the second scroll animation as the angle increases.

According to an embodiment, the first screen may comprise a list of visual objects. The one or more programs may include instructions to, when executed by the wrist-wearable electronic device, cause the wrist-wearable electronic device to, in accordance with the first determination indicating that the angle is included in the first angle range, determine, in a second determination, whether the user input information includes scroll information of the finger-wearable electronic device or gyro information of the finger-wearable electronic device. The one or more programs may include instructions to, when executed by the wrist-wearable electronic device, cause the wrist-wearable electronic device to, in accordance with the second determination indicating that the user input information includes the scroll information, display, via the display, a first scroll animation in which each of the visual objects is scrolled. The one or more programs may include instructions to, when executed by the wrist-wearable electronic device, cause the wrist-wearable electronic device to, in accordance with the second determination indicating that the user input information includes the gyro information, display, via the display, a second scroll animation in which each of groups of the visual objects is scrolled.

According to an embodiment, the one or more programs may include instructions to, when executed by the wrist-wearable electronic device, cause the wrist-wearable electronic device to, in accordance with the first determination indicating that the angle is included in the first angle range, display, via the display, a first visual object for guiding scrolling of the first screen in a first direction of an axis parallel to a strap of the wrist-wearable electronic device and a second visual object for guiding scrolling of the first screen in a second direction opposite to the first direction. The one or more programs may include instructions to, when executed by the wrist-wearable electronic device, cause the wrist-wearable electronic device to, in accordance with the first determination indicating that the angle is included in the second angle range, display, via the display, a third visual object for guiding scrolling of the first screen in a third direction perpendicular to the first direction and a fourth visual object for guiding scrolling of the first screen in a fourth direction opposite to the third direction.

According to an embodiment, the one or more programs may include instructions to, when executed by the wrist-wearable electronic device, cause the wrist-wearable electronic device to, based on identifying that the scrolling of the first screen in the first direction has failed a predetermined number of times, display, via the display, a visual effect for the first visual object.

According to an embodiment, the one or more programs may include instructions to, when executed by the wrist-wearable electronic device, cause the wrist-wearable electronic device to, after changing the first screen to the second screen or the third screen, obtain, via the sensor, a gesture input of a hand connected to a wrist wearing the wrist-wearable electronic device. The instructions, when executed by the at least one processor individually or collectively, may cause the wrist-wearable electronic device to execute a function corresponding to the gesture input.

According to an embodiment, the one or more programs may include instructions to, when executed by the wrist-wearable electronic device, cause the wrist-wearable electronic device to, after changing the first screen to the second screen or the third screen, receive, via the communication circuitry, additional user input information from the finger-wearable electronic device. The one or more programs may include instructions to, when executed by the wrist-wearable electronic device, cause the wrist-wearable electronic device to, based on identifying that the additional user input information is less than reference user input information, provide a gesture mode for recognizing a movement of a hand connected to a wrist wearing the wrist-wearable electronic device as an input. The one or more programs may include instructions to, when executed by the wrist-wearable electronic device, cause the wrist-wearable electronic device to, while providing the gesture mode, based on identifying a gesture input of the hand obtained via the sensor, execute a function corresponding to the gesture input.

According to an embodiment, the instructions, when executed by the at least one processor individually or collectively, may cause the wrist-wearable electronic device to provide a gesture mode for recognizing a movement of a hand connected to a wrist wearing the wrist-wearable electronic device as an input. The one or more programs may include instructions to, when executed by the wrist-wearable electronic device, cause the wrist-wearable electronic device to, while providing the gesture mode, receive, via the communication circuitry, additional user input information from the finger-wearable electronic device. The one or more programs may include instructions to, when executed by the wrist-wearable electronic device, cause the wrist-wearable electronic device to, while providing the gesture mode, select a visual object within a screen displayed via the display in accordance with the additional user input information. The one or more programs may include instructions to, when executed by the wrist-wearable electronic device, cause the wrist-wearable electronic device to, while providing the gesture mode, based on identifying a gesture input of the hand obtained via the sensor, execute a function corresponding to the selected visual object.

According to an embodiment, the one or more programs may include instructions to, when executed by the wrist-wearable electronic device, cause the wrist-wearable electronic device to, while providing the gesture mode, based on identifying an input for releasing the gesture mode, obtain additional information related to another angle between the wrist-wearable electronic device and the finger-wearable electronic device. The one or more programs may include instructions to, when executed by the wrist-wearable electronic device, cause the wrist-wearable electronic device to, based on the additional information related to the other angle, determine, in a second determination, whether the other angle is included in the first angle range or the second angle range. The one or more programs may include instructions to, when executed by the wrist-wearable electronic device, cause the wrist-wearable electronic device to, in accordance with the second determination indicating that the other angle is included in the first angle range, receive, via the communication circuitry, second additional user input information for the finger-wearable electronic device from the finger-wearable electronic device. The one or more programs may include instructions to, when executed by the wrist-wearable electronic device, cause the wrist-wearable electronic device to, in accordance with the second determination indicating that the other angle is included in the first angle range, based on the second additional user input information, display, via the display, a fifth screen. The one or more programs may include instructions to, when executed by the wrist-wearable electronic device, cause the wrist-wearable electronic device to, in accordance with the second determination indicating that the other angle is included in the second angle range, receive, via the communication circuitry, the second additional user input information from the finger-wearable electronic device. The one or more programs may include instructions to, when executed by the wrist-wearable electronic device, cause the wrist-wearable electronic device to, in accordance with the second determination indicating that the other angle is included in the second angle range, based on the second additional user input information, display, via the display, a sixth screen distinguished from the fifth screen.

According to an embodiment, the one or more programs may include instructions to, when executed by the wrist-wearable electronic device, cause the wrist-wearable electronic device to, in accordance with the first determination indicating that the angle is included in the first angle range, based on identifying that changing the first screen to the second screen is impossible, determine a failure of an input. According to an embodiment, the one or more programs may include instructions to, when executed by the wrist-wearable electronic device, cause the wrist-wearable electronic device to, in accordance with the first determination indicating that the angle is included in the first angle range, based on identifying that the number of failures of the input is greater than a reference number, execute a function to correct an operation for determining the angle.

According to an embodiment, the one or more programs may include instructions to, when executed by the wrist-wearable electronic device, cause the wrist-wearable electronic device to, in accordance with the first determination indicating that the angle is included in the first angle range, based on identifying that another angle between the wrist-wearable electronic device and the finger-wearable electronic device is included in the second angle range, determine a change of a mode. The one or more programs may include instructions to, when executed by the wrist-wearable electronic device, cause the wrist-wearable electronic device to, based on identifying the number of changes of the mode being greater than a reference number during a reference time, execute a function to correct an operation for determining the angle.

According to an embodiment, the one or more programs may include instructions to, when executed by the wrist-wearable electronic device, cause the wrist-wearable electronic device to, while the first screen is displayed via the display, obtain, via the sensor, the sensor data. The one or more programs may include instructions to, when executed by the wrist-wearable electronic device, cause the wrist-wearable electronic device to, while the first screen is displayed via the display, receive, via the communication circuitry, additional sensor data of the finger-wearable electronic device from the finger-wearable electronic device. The one or more programs may include instructions to, when executed by the wrist-wearable electronic device, cause the wrist-wearable electronic device to, while the first screen is displayed via the display, based on the sensor data and the additional sensor data, obtain the information related to the angle between the wrist-wearable electronic device and the finger-wearable electronic device.

While aspects of embodiments have been particularly shown and described, it will be understood that various changes in form and details may be made therein without departing from the spirit and scope of the following claims.

No claim element is to be construed under the provisions of 35 U.S.C. § 112, sixth paragraph, unless the element is expressly recited using the phrase “means for” or “means”.

What is claimed is:

1. A wrist-wearable electronic device comprising:
a sensor;
communication circuitry;
a display;
memory comprising one or more storage media storing instructions; and
at least one processor comprising processing circuitry,
wherein the instructions, when executed by the at least one processor individually or collectively, cause the wrist-wearable electronic device to:
while a first screen is displayed via the display, based on sensor data obtained via the sensor, obtain information related to an angle between the wrist-wearable electronic device and a finger-wearable electronic device connected to the wrist-wearable electronic device,
based on the information related to the angle, determine, in a first determination, whether the angle is included in a first angle range or a second angle range distinguished from the first angle range,
receive, via the communication circuitry, a user input information for the finger-wearable electronic device from the finger-wearable electronic device,
based on the user input information being received from the finger-wearable electronic device and the first determination indicating that the angle is included in the first angle range, display, via the display, a second screen changed from the first screen, and
based on the user input information being received from the finger-wearable electronic device and the first determination indicating that the angle is included in the second angle range, display, via the display, a third screen, changed from the first screen, distinguished from the second screen.

2. The wrist-wearable electronic device of claim 1, wherein the instructions, when executed by the at least one processor individually or collectively, cause the wrist-wearable electronic device to:
in accordance with the first determination indicating that the angle is included in the first angle range, while changing the first screen to the second screen, display, via the display, a first scroll animation in which the first screen moves along a first axis parallel to a strap of the wrist-wearable electronic device, and
in accordance with the first determination indicating that the angle is included in the second angle range, while changing the first screen to the third screen, display, via the display, a second scroll animation in which the first screen moves along a second axis perpendicular to the first axis.

3. The wrist-wearable electronic device of claim 2, wherein the instructions, when executed by the at least one processor individually or collectively, cause the wrist-wearable electronic device to:
increase a velocity of the first scroll animation and a velocity of the second scroll animation as the angle increases.

4. The wrist-wearable electronic device of claim 1, wherein the first screen comprises a list of visual objects, and
wherein the instructions, when executed by the at least one processor individually or collectively, cause the wrist-wearable electronic device to:
in accordance with the first determination indicating that the angle is included in the first angle range, determine, in a second determination, whether the user input information includes scroll information of the finger-wearable electronic device or gyro information of the finger-wearable electronic device,
in accordance with the second determination indicating that the user input information includes the scroll information, display, via the display, a first scroll animation in which each of the visual objects is scrolled, and
in accordance with the second determination indicating that the user input information includes the gyro information, display, via the display, a second scroll animation in which each of groups of the visual objects is scrolled.

5. The wrist-wearable electronic device of claim 1, wherein the instructions, when executed by the at least one processor individually or collectively, cause the wrist-wearable electronic device to:
in accordance with the first determination indicating that the angle is included in the first angle range, display, via the display, a first visual object for guiding scrolling of the first screen in a first direction of an axis parallel to a strap of the wrist-wearable electronic device and a second visual object for guiding scrolling of the first screen in a second direction opposite to the first direction, and
in accordance with the first determination indicating that the angle is included in the second angle range, display, via the display, a third visual object for guiding scrolling of the first screen in a third direction perpendicular to the first direction and a fourth visual object for guiding scrolling of the first screen in a fourth direction opposite to the third direction.

6. The wrist-wearable electronic device of claim 5, wherein the instructions, when executed by the at least one processor individually or collectively, cause the wrist-wearable electronic device to:
based on identifying that the scrolling of the first screen in the first direction has failed a predetermined number of times, display, via the display, a visual effect for the first visual object.

7. The wrist-wearable electronic device of claim 1, wherein the instructions, when executed by the at least one processor individually or collectively, cause the wrist-wearable electronic device to:
after changing the first screen to the second screen or the third screen, obtain, via the sensor, a gesture input of a hand connected to a wrist wearing the wrist-wearable electronic device, and
execute a function corresponding to the gesture input.

8. The wrist-wearable electronic device of claim 1, wherein the instructions, when executed by the at least one processor individually or collectively, cause the wrist-wearable electronic device to:
after changing the first screen to the second screen or the third screen, receive, via the communication circuitry, additional user input information from the finger-wearable electronic device,
based on identifying that the additional user input information is less than reference user input information, provide a gesture mode for recognizing a movement of a hand connected to a wrist wearing the wrist-wearable electronic device as an input, and
while providing the gesture mode, based on identifying a gesture input of the hand obtained via the sensor, execute a function corresponding to the gesture input.

9. The wrist-wearable electronic device of claim 1, wherein the instructions, when executed by the at least one processor individually or collectively, cause the wrist-wearable electronic device to:
provide a gesture mode for recognizing a movement of a hand connected to a wrist wearing the wrist-wearable electronic device as an input,
while providing the gesture mode:
receive, via the communication circuitry, additional user input information from the finger-wearable electronic device,
select a visual object within a screen displayed via the display in accordance with the additional user input information, and
based on identifying a gesture input of the hand obtained via the sensor, execute a function corresponding to the selected visual object.

10. The wrist-wearable electronic device of claim 9, wherein the instructions, when executed by the at least one processor individually or collectively, cause the wrist-wearable electronic device to:
while providing the gesture mode, based on identifying an input for releasing the gesture mode, obtain additional information related to another angle between the wrist-wearable electronic device and the finger-wearable electronic device,
based on the additional information related to the other angle, determine, in a second determination, whether the other angle is included in the first angle range or the second angle range,
in accordance with the second determination indicating that the other angle is included in the first angle range:
receive, via the communication circuitry, second additional user input information for the finger-wearable electronic device from the finger-wearable electronic device, and
based on the second additional user input information, display, via the display, a fifth screen, and
in accordance with the second determination indicating that the other angle is included in the second angle range:
receive, via the communication circuitry, the second additional user input information from the finger-wearable electronic device, and
based on the second additional user input information, display, via the display, a sixth screen distinguished from the fifth screen.

11. The wrist-wearable electronic device of claim 1, wherein the instructions, when executed by the at least one processor individually or collectively, cause the wrist-wearable electronic device to:
in accordance with the first determination indicating that the angle is included in the first angle range:
based on identifying that changing the first screen to the second screen is impossible, determine a failure of an input, and
based on identifying that the number of failures of the input is greater than a reference number, execute a function to correct an operation for determining the angle.

12. The wrist-wearable electronic device of claim 1, wherein the instructions, when executed by the at least one processor individually or collectively, cause the wrist-wearable electronic device to:
in accordance with the first determination indicating that the angle is included in the first angle range, based on identifying that another angle between the wrist-wearable electronic device and the finger-wearable electronic device is included in the second angle range, determine a change of a mode, and
based on identifying the number of changes of the mode being greater than a reference number during a reference time, execute a function to correct an operation for determining the angle.

13. The wrist-wearable electronic device of claim 1, wherein the instructions, when executed by the at least one processor individually or collectively, cause the wrist-wearable electronic device to:
while the first screen is displayed via the display:
obtain, via the sensor, the sensor data,
receive, via the communication circuitry, additional sensor data of the finger-wearable electronic device from the finger-wearable electronic device, and
based on the sensor data and the additional sensor data, obtain the information related to the angle between the wrist-wearable electronic device and the finger-wearable electronic device.

14. A method performed by a wrist-wearable electronic device with a display, communication circuitry, and a sensor, the method comprising:
while a first screen is displayed via the display, based on sensor data obtained via the sensor, obtaining information related to an angle between the wrist-wearable electronic device and a finger-wearable electronic device connected to the wrist-wearable electronic device,
based on the information related to the angle, determining, in a first determination, whether the angle is included in a first angle range or a second angle range distinguished from the first angle range,
receiving, via the communication circuitry, a user input information for the finger-wearable electronic device from the finger-wearable electronic device,
based on the user input information being received from the finger-wearable electronic device and the first determination indicating that the angle is included in the first angle range, displaying, via the display, a second screen changed from the first screen, and
based on the user input information being received from the finger-wearable electronic device and the first determination indicating that the angle is included in the second angle range, displaying, via the display, a third screen, changed from the first screen, distinguished from the second screen.

15. A non-transitory computer readable storage medium storing one or more programs, the one or more programs comprising instructions to, when executed by a wrist-wearable electronic device with a display, communication circuitry, and a sensor, cause the wrist-wearable electronic device to:
while a first screen is displayed via the display, based on sensor data obtained via the sensor, obtain information related to an angle between the wrist-wearable electronic device and a finger-wearable electronic device connected to the wrist-wearable electronic device,
based on the information related to the angle, determine, in a first determination, whether the angle is included in a first angle range or a second angle range distinguished from the first angle range,
receive, via the communication circuitry, a user input information for the finger-wearable electronic device from the finger-wearable electronic device,
based on the user input information, the user input information being received from the finger-wearable electronic device and the first determination indicating that the angle is included in the first angle range, display, via the display, a second screen changed from the first screen, and
based on the user input information being received from the finger-wearable electronic device and the first determination indicating that the angle is included in the second angle range, display, via the display, a third screen, changed from the first screen, distinguished from the second screen.

16. The non-transitory computer readable storage medium of claim 15,
wherein the one or more programs comprise instructions, when executed by the wrist-wearable electronic device, cause the wrist-wearable electronic device to:
in accordance with the first determination indicating that the angle is included in the first angle range, while changing the first screen to the second screen, display, via the display, a first scroll animation in which the first screen moves along a first axis parallel to a strap of the wrist-wearable electronic device, and
in accordance with the first determination indicating that the angle is included in the second angle range, while changing the first screen to the third screen, display, via the display, a second scroll animation in which the first screen moves along a second axis perpendicular to the first axis.

17. The non-transitory computer readable storage medium of claim 16,
wherein the one or more programs comprise instructions, when executed by the wrist-wearable electronic device, cause the wrist-wearable electronic device to:
increase a velocity of the first scroll animation and a velocity of the second scroll animation as the angle increases.

18. The non-transitory computer readable storage medium of claim 15, wherein the first screen comprises a list of visual objects, and
wherein the one or more programs comprise instructions, when executed by the wrist-wearable electronic device, cause the wrist-wearable electronic device to:
in accordance with the first determination indicating that the angle is included in the first angle range, determine, in a second determination, whether the user input information includes scroll information of the finger-wearable electronic device or gyro information of the finger-wearable electronic device,
in accordance with the second determination indicating that the user input information includes the scroll information, display, via the display, a first scroll animation in which each of the visual objects is scrolled, and
in accordance with the second determination indicating that the user input information includes the gyro information, display, via the display, a second scroll animation in which each of groups of the visual objects is scrolled.

19. The non-transitory computer readable storage medium of claim 15,
wherein the one or more programs comprise instructions, when executed by the wrist-wearable electronic device, cause the wrist-wearable electronic device to:
in accordance with the first determination indicating that the angle is included in the first angle range, display, via the display, a first visual object for guiding scrolling of the first screen in a first direction of an axis parallel to a strap of the wrist-wearable electronic device and a second visual object for guiding scrolling of the first screen in a second direction opposite to the first direction, and
in accordance with the first determination indicating that the angle is included in the second angle range, display, via the display, a third visual object for guiding scrolling of the first screen in a third direction perpendicular to the first direction and a fourth visual object for guiding scrolling of the first screen in a fourth direction opposite to the third direction.

20. The non-transitory computer readable storage medium of claim 19, wherein the one or more programs comprise instructions, when executed by the wrist-wearable electronic device, cause the wrist-wearable electronic device to:
based on identifying that the scrolling of the first screen in the first direction has failed a predetermined number of times, display, via the display, a visual effect for the first visual object.
